(19) United States
(12) Patent Application Publication
(10) Pub. No.: US 2025/0293811 A1
(43) Pub. Date: Sep. 18, 2025

(54) HYBRID AUTOMATIC REPEAT REQUEST DISABLEMENT

(71) Applicant: Apple Inc., Cupertino, CA (US)

(72) Inventors: Chunxuan Ye, San Diego, CA (US); Chunhai Yao, Beijing (CN); Dawei Zhang, Saratoga, CA (US); Haitong Sun, Saratoga, CA (US); Hong He, San Jose, CA (US); Seyed Ali Akbar Fakoorian, San Diego, CA (US); Sigen Ye, San Diego, CA (US); Wei Zeng, Saratoga, CA (US); Weidong Yang, San Diego, CA (US); Yushu Zhang, Beijing (CN)

(73) Assignee: Apple Inc., Cupertino, CA (US)

(21) Appl. No.: 18/861,156

(22) PCT Filed: Apr. 21, 2023
(86) PCT No.: PCT/US2023/019459

§ 371 Date: Oct. 28, 2024

Related U.S. Application Data
(60) Provisional application No. 63/336,276, filed on Apr. 28, 2022.

(51) Int. Cl. H04L 1/1812

(52) U.S. Cl. CPC H04L 1/1812

(57) ABSTRACT

The present application relates to devices and components including apparatus, systems, and methods to provide hybrid automatic repeat request disablement in wireless communication systems.

### CROSS-REFERENCE TO RELATED APPLICATIONS

This application claims priority to U.S. provisional application No. 63/336,276, entitled “Hybrid Automatic Repeat Request Disablement,” filed on Apr. 28, 2022, the disclosure of which is incorporated by reference herein in its entirety for all purposes.

### TECHNICAL FIELD

The present application relates to the field of wireless technologies and, in particular, to provide hybrid automatic repeat request disablement in wireless communication system.

### BACKGROUND

Third Generation Partnership Project (3GPP) networks provide approaches for verifying communications and/or operations between base stations and user equipments (UEs). One of these approaches is hybrid automatic repeat request (HARQ) feedback. UEs report HARQ feedback to base stations to indicate that communications have been properly received and/or operations have been properly performed. The base stations monitor for the HARQ feedback from the UEs.

### BRIEF DESCRIPTION OF THE DRAWINGS

FIG. 1 illustrates a signal chart of an example of the signaling of disabling hybrid automatic repeat request (HARQ) feedback in accordance with some embodiments.

FIG. 2 illustrates a diagram showing an example of masking cyclic redundancy check (CRC) for indicating whether HARQ feedback is to be enabled or disabled in accordance with some embodiments.

FIG. 3 illustrates an example procedure for dynamic disabling per downlink control information (DCI) using a radio network temporary identifier (RNTI) to indicate whether HARQ feedback is to be disabled in accordance with some embodiments.

FIG. 4 illustrates an example procedure of hybrid signaling operation in accordance with some embodiments.

FIG. 5 illustrates a signal chart of HARQ-acknowledgement (ACK) reporting in accordance with some embodiments.

FIG. 6 illustrates an example information element that includes codebooksizeDetermination-r13 in accordance with some embodiments.

FIG. 7 illustrates an example information element that includes codebooksizeDeterminationSTTI in accordance with some embodiments.

FIG. 8 illustrates an example diagram showing the HARQ-ACK bundling case with a portion of the HARQ processes having HARQ feedback disabled in accordance with some embodiments.

FIG. 9 illustrates a physical downlink shared channel (PDSCH) timing representation in accordance with some embodiments.

FIG. 10 illustrates an example procedure of operating a base station in an internet of things (IoT) non-terrestrial network (NTN) in accordance with some embodiments.

FIG. 11 illustrates an example procedure of operating a user equipment (UE) in an IoT NTN in accordance with some embodiments.

FIG. 12 illustrates a network environment in accordance with some embodiments.

FIG. 13 illustrates an example UE in accordance with some embodiments.

FIG. 14 illustrates an example next generation nodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

In legacy third generation partnership project (3GPP) internet of things (IoT) non-terrestrial network (NTN), hybrid automatic repeat request (HARQ) feedback is utilized to indicate that a signal has been received properly. However, in some instances HARQ may stall causing data rates to decrease and negatively impact performance. Accordingly, disabling HARQ feedback may be desired in some instances to prevent HARQ stalling. Further, disabling HARQ feedback may reduce power consumption and connection times. Approaches for disabling HARQ feedback in IoT NTN are disclosed herein.

### Information: IoT NTN

In Release 18 IoT NTN work item description has an objective of IoT-NTN Performance Enhancements in release 18 (Rel-18) to address remaining issues from release 17 (Rel-17). This disclosure considers Rel-17 IoT-NTN as baseline as well as Rel-17 NR-NTN outcome. The further IoT-NTN performance enhancements objectives include: 1) disabling of HARQ feedback to mitigate impact of HARQ stalling on user equipment (UE) data rates [radio access network work group 1 (RAN1), radio access network work group 2 (RAN2)]; 2) study and specify, if needed, improved global navigation satellite system (GNSS) operations for a new position fix for UE pre-compensation during long connection times and for reduced power consumption. Simultaneous GNSS and NTN narrowband-IoT (NB-IoT)/enhanced machine type communication (eMTC) operation is not assumed. [RAN1]. NOTE: The need for radio access network work group 4 (RAN4) Core requirements for this objective may be identified after the conclusion on the need for improvements.

### Information: Rel-17 New Radio (NR) NTN

In 3GPP Release 17 NR NTN, the following agreements related to HARQ feedback disabling have been made. Enabling/disabling on HARQ feedback for downlink transmission should be at least configurable per HARQ process via UE specific radio resource control (RRC) signaling. Confirm the previous working assumption for X=T_proc, 1 where X is defined from the end of the reception of the last physical downlink shared channel (PDSCH) or slot-aggregated PDSCH for a given HARQ process with disabled feedback to the start of the physical downlink control channel (PDCCH) carrying the downlink control information (DCI) scheduling another PDSCH or set of slot-aggregated PDSCH or the PDSCH without corresponding PDCCH for the given HARQ process. The bit-fields related to the hybrid automatic repeat request acknowledgement (HARQ-ACK) feedback (i.e., physical uplink control channel resource index (PRI), physical uplink shared channel (PUSCH)-to-HARQ feedback timing, downlink assignment index (DAI)) are unchanged for the DCI of PDSCH with feedback-disabled HARQ process in Rel-17 with the same interpretation from UE as for feedback-enabled HARQ process. For HARQ feedback of each semi-persistent scheduling (SPS) PDSCH, UE follows the per-process configuration of HARQ feedback enabled/disabled for the associated HARQ process, except for the first SPS PDSCH after activation if HARQ feedback for SPS activation is additionally enabled. For Type-1 HARQ codebook, the UE will consistently report negative acknowledgement (NACK)-only for the feedback-disabled HARQ process regardless of decoding results of corresponding PDSCH. For Type-2 HARQ codebook in NTN: Reduce codebook size with HARQ-ACK codebook only including HARQ-ACK of PDSCH with feedback-enabled HARQ processes. The details of counter downlink assignment index (C-DAI) and total downlink assignment index (T-DAI) counting for DCI of PDSCH with feedback-enable/disabled HARQ processes may be for further study.

### Issue Statement

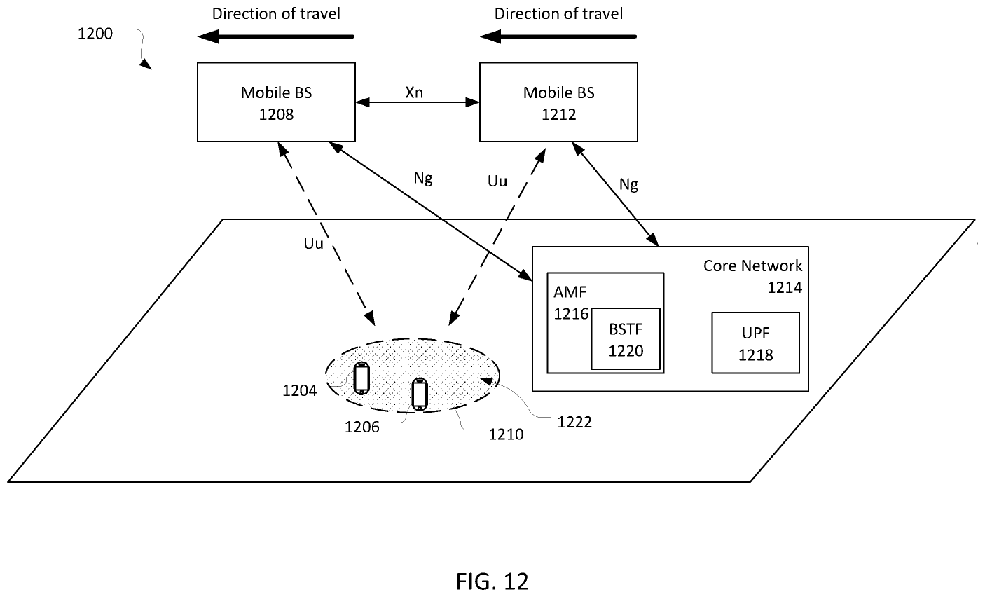

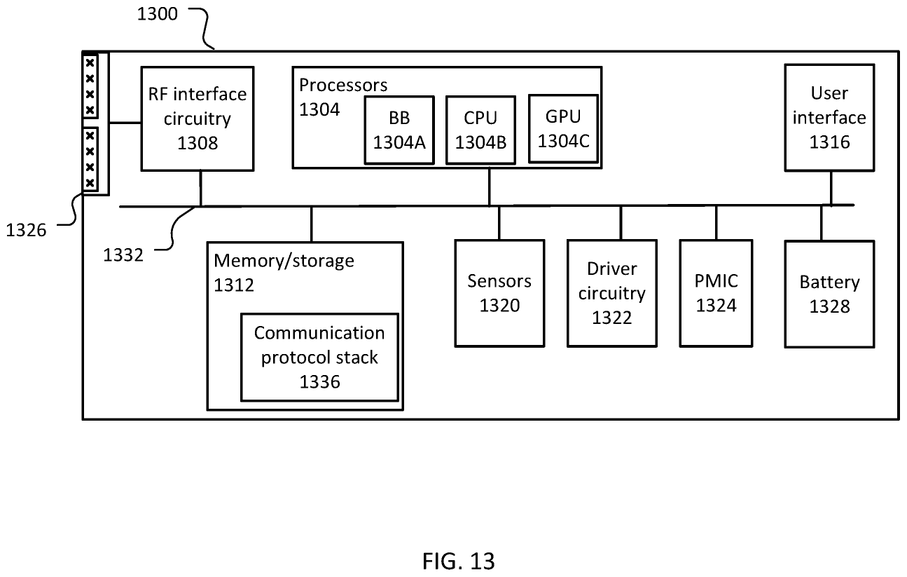

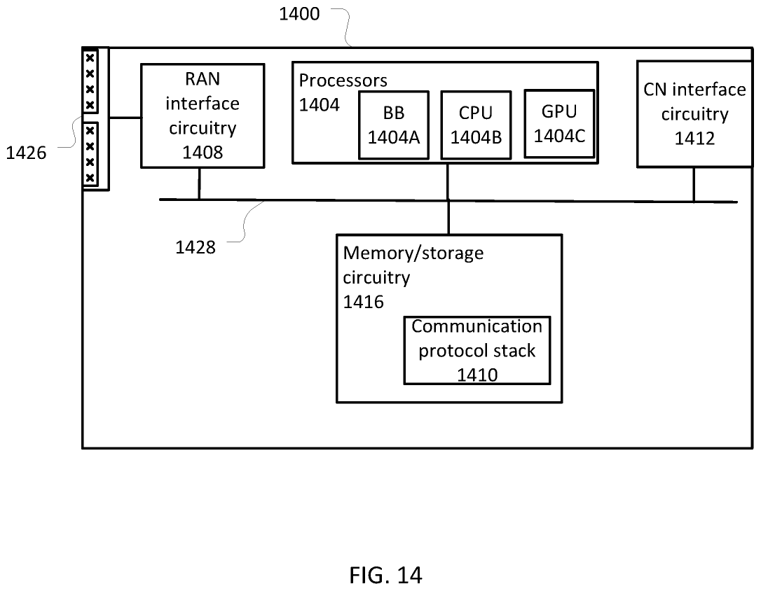

General issue: How to support the disabling HARQ feedback in IoT NTN? Signaling of disabling HARQ feedback may support the disabling of HARQ feedback in IoT NTN in some embodiments. The signaling of disabling HARQ feedback may be semi-static or dynamic. For example, a user equipment (UE) (such as the UE 1204 (FIG. 12), the UE 1206 (FIG. 12), and/or the UE 1300 (FIG. 13)) may provide signaling to a base station (such as the base station 1208 (FIG. 12), the base station 1212 (FIG. 12), and/or the gNB 1400 (FIG. 14)) to cause the HARQ feedback to be disabled.

HARQ-ACK reporting in case of feedback disabled HARQ may support the disabling of HARQ feedback in IoT NTN in some embodiments. HARQ-ACK reporting may include HARQ-ACK codebook construction with transmission time interval (TTI) bundling and/or HARQ-ACK reporting with channel selection.

Feedback disabled HARQ in SPS may support the disabling of HARQ feedback in IoT NTN in some embodiments. The feedback disabled HARQ in SPS may include SPS activation, SPS release, and/or SPS PDSCH. Processing time restrictions in case of feedback disabled HARQ may support the disabling of HARQ feedback in IoT NTN in some embodiments.

### Approach 1: Signaling of Disabling HARQ Feedback

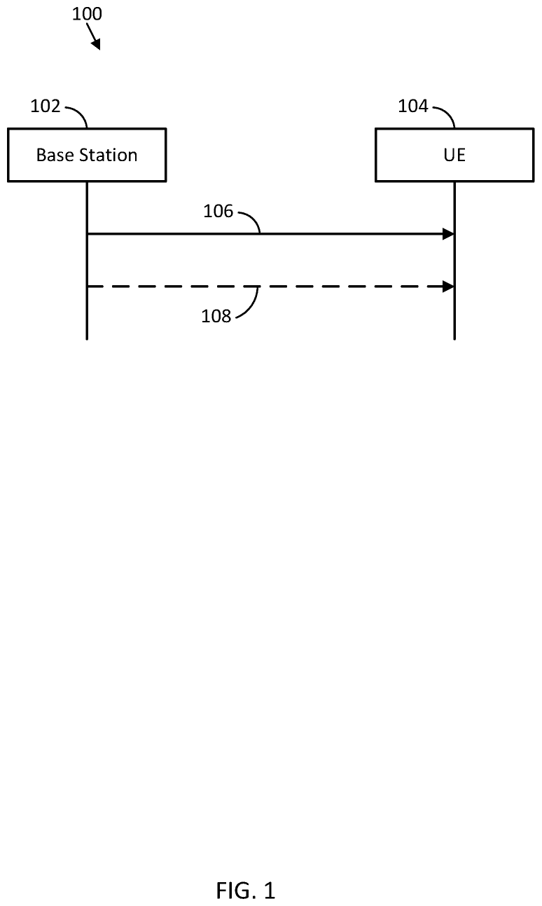

Approach 1: Signaling of disabling HARQ feedback. The signaling of disabling HARQ feedback may include both downlink (DL) HARQ processes and uplink (UL) HARQ processes. FIG. 1 illustrates a signal chart 100 of an example of the signaling of disabling HARQ feedback in accordance with some embodiments. In particular, the signal chart 100 illustrates signaling that may be performed to indicate whether HARQ feedback is to be disabled in a IoT NTN.

The signal chart 100 includes a base station 102. The base station 102 may include one or more of the features of the base station 1208 (FIG. 12), the base station 1212 (FIG. 12), and/or the gNB 1400 (FIG. 14). The base station 102 may be part of an NTN serving IoT UEs.

The signal chart 100 further includes a UE 104. The UE 104 may include one or more of the features of the UE 1204 (FIG. 12), the UE 1206 (FIG. 12), and/or the UE 1300 (FIG. 13). The UE 104 may be operating as part of an IoT NTN. For example, the base station 102 may be serving the UE 104 as part of an IoT NTN in the illustrated embodiment.

The base station 102 may transmit a control transmission 106 to UE 104. The control transmission 106 may indicate whether HARQ feedback is to be disabled for communications between the UE 104 and the base station 102. For example, the control transmission 106 may include one or more of the elements described in the following alternative 1, alternative 2, and/or alternative 3 to indicate whether HARQ feedback is to be disabled.

Alternative 1: Configuration of feedback disabling per HARQ process number. In the UE specific configuration of PDSCH or PUSCH, disabling HARQ feedback per HARQ process. For example, the control transmission 106 transmitted from the base station 102 to the UE 104 may include a process number corresponding to a HARQ process for which HARQ feedback is to be disabled. In the information element (IE) of “PDSCH-ConfigDedicated” or “PUSCH-ConfigDedicated”, add a field of indicating HARQ feedback disabling. For example, the control transmission 106 may include a PDSCH-ConfigDedicated information element or a PUSCH-ConfigDedicated information element. The PDSCH-ConfigDedicated information element or the PUSCH-ConfigDedicated information element in the control transmission 106 may include an indication that a HARQ process that a HARQ process is to be disabled. Further, the PDSCH-ConfigDedicated information element or the PUSCH-ConfigDedicated information element may include a HARQ process number corresponding to the HARQ process to be disabled.

In alternative 1, for the DCI with HARQ process configured with disabling feedback, the “Downlink Assignment Index” (DAI) field is not used by UE or is re-interpreted by UE. For example, the UE may not use the DAI field or the bits previously utilized for the DAI field may be utilized for other information when the HARQ process feedback has been disabled. The “HARQ-ACK delay” field and the “HARQ-ACK resource offset” field are not used by UE or is re-interpreted by UE. For example, the UE may not use the HARQ-ACK delay field and the HARQ-ACK resource offset field when the HARQ feedback has been disabled in some embodiments. Additionally, the UE may use the bits previously utilized for the HARQ-ACK delay field and the HARQ-ACK resource offset field for other information when the HARQ process feedback has been disabled. The “Transport blocks in a bundle” field and the “HARQ-ACK bundling flag” field are not used by UE or is re-interpreted by UE. For example, the UE may not use the transport blocks in a bundle field and the HARQ-ACK bundling flag field when the HARQ feedback has been disabled in some embodiments. Additionally, the UE may use the bits previously utilized for the transport blocks in a bundle field and the HARQ-ACK bundling flag field for other information when the HARQ process feedback has been disabled. The “New data indicator” field in the UL grant and physical channel hybrid automatic repeat request indicator channel (PHICH) is ignored by the UE for disabled UL HARQ process. For example, the UE may ignore the new data indicator field in the UL grant and the PHICH when a UL HARQ process is disabled.

Alternative 2: Dynamic disabling per DCI. For example, control transmission 106 transmitted from the base station 102 to the UE 104 may include DCI that indicates that HARQ feedback is to be disabled for a HARQ process. In particular, the DCI may schedule a HARQ process, where the DCI may indicate whether the HARQ process being scheduled is to have the HARQ feedback to be disabled for the HARQ process.

Option 1 of alternative 2: Explicit 1-bit field to indicate whether the feedback is disabled for the HARQ process scheduled by the DCI. For example, the DCI included in the control transmission 106 may include a field that indicates whether a HARQ process being scheduled by the DCI is to have the HARQ feedback corresponding with the HARQ process disabled. The field in the DCI may be a 1-bit field, where the one value of the 1-bit field may indicate that the HARQ feedback is to be provided, whereas the other value of the 1-bit field may indicate that the HARQ feedback is to be disabled.

Option 2 of alternative 2: Use a different radio network temporary identifier (RNTI) (different from cell radio network temporary identifier (C-RNTI)) to indicate whether the feedback is disabled for the HARQ process scheduled by the DCI. For example, the control transmission 106 may include a cyclic redundancy check (CRC) corresponding to the DCI. The CRC may be masked by an RNTI. The base station 102 may use different RNTI values in the CRC mask to indicate whether the HARQ feedback is to be disabled for a HARQ process being scheduled by the DCI. In some embodiments, the base station 102 may use the C-RNTI to mask DCI CRC for the corresponding cell to indicate that the HARQ process is to have HARQ feedback enabled and may use an RNTI different from the C-RNTI to mask DCI CRC to indicate that the HARQ process is have the HARQ feedback disabled.

Further for option 2 of alternative 2: cyclic redundancy check (CRC) masked with RNTI. Option 2: UE procedure of determining whether HARQ feedback for the current downlink data transmission is enabled or disabled. For example, the base station 102 may mask the CRC with an RNTI to indicate whether HARQ feedback is to be enabled or disabled for a DL data transmission.

Further for option 3 of alternative 2: a codepoint of an existing field is used to indicate whether the feedback is disabled for the HARQ process scheduled by the DCI. For example, the field “HARQ-ACK delay” or the field “HARQ-ACK resource offset” may have a codepoint to indicate the HARQ-ACK feedback is disabled. The DCI included in the control transmission 106 may have a codepoint of the HARQ-ACK delay field or a codepoint of the HARQ-ACK resource offset set to a certain values to indicate whether the HARQ-ACK feedback is disabled.

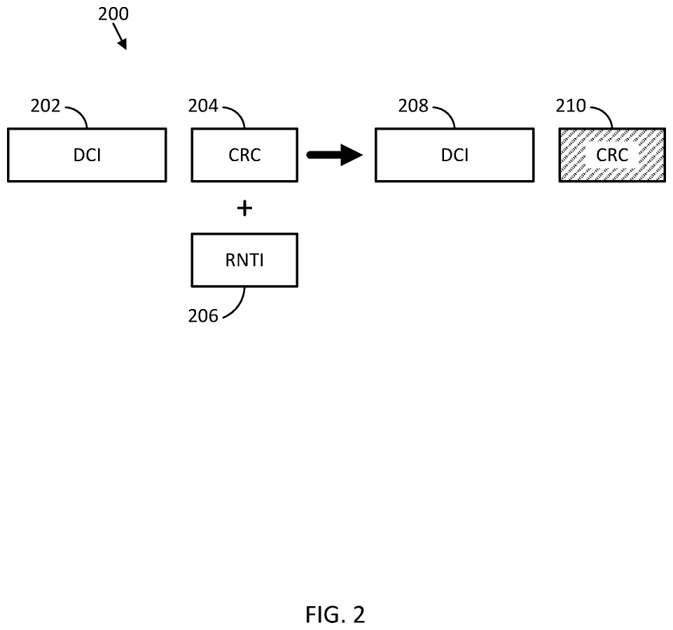

FIG. 2 illustrates a diagram 200 showing an example of masking CRC for indicating whether HARQ feedback is to be enabled or disabled in accordance with some embodiments. For example, the diagram 200 illustrates blocks that may be transmitted by a base station (such as the base station 102 (FIG. 1)) to a UE (such as the UE 104 (FIG. 1)) to indicate whether HARQ feedback is to be enabled or disabled for a DL data transmission.

The diagram 200 includes a first DCI 202. The base station may generate the first DCI 202 to be included in a control transmission (such as the control transmission 106 (FIG. 1)) for transmission to the UE. The first DCI 202 may be utilized for scheduling a HARQ process. A DL data transmission related to the HARQ process may be transmitted by the base station to the UE after the HARQ process has finished.

The diagram 200 further includes a first CRC 204. The first CRC 204 may correspond to the first DCI 202, where the first CRC 204 and the first DCI 202 may be transmitted in the same control transmission. The first CRC 204 may be a CRC for the first DCI 202.

The diagram 200 further includes an RNTI 206. The RNTI 206 may comprise an RNTI that is different from a C-RNTI corresponding to the first DCI 202. The UE may utilize the RNTI 206 to mask the first CRC 204 to indicate that a HARQ feedback corresponding to a HARQ process being scheduled by the first DCI 202 is to have the HARQ feedback disabled. The diagram 200 further includes a second DCI 208 and a second CRC 210. The second DCI 208 and the second CRC 210 may be the output of the base station based on the first DCI 202, the first CRC 204, and/or the RNTI 206. For example, the second DCI 208 and the second CRC 210 may be the DCI and the CRC, respectively, transmitted by the base station to the UE to indicate whether the HARQ feedback is to be disabled for the HARQ process. The second DCI 208 may be equivalent to the first DCI 202. The second CRC 210 may be the result of the decision by the base station whether to mask the first CRC 204 with the RNTI 206. For example, the second CRC 210 may be equivalent to the first CRC 204 exclusive OR (XOR) with the C-RNTI if the base station is indicating that the HARQ feedback is to be enabled. However, if the base station is indicating that the HARQ feedback is to be disabled, the second CRC 210 may be equivalent to the first CRC 204 XOR with the RNTI 206 rather than a C-RNTI to indicate that the HARQ feedback is to be disabled. The UE may receive the second DCI 208 and the second CRC 210 and determine whether HARQ feedback for a current downlink data transmission is to be enabled or disabled.

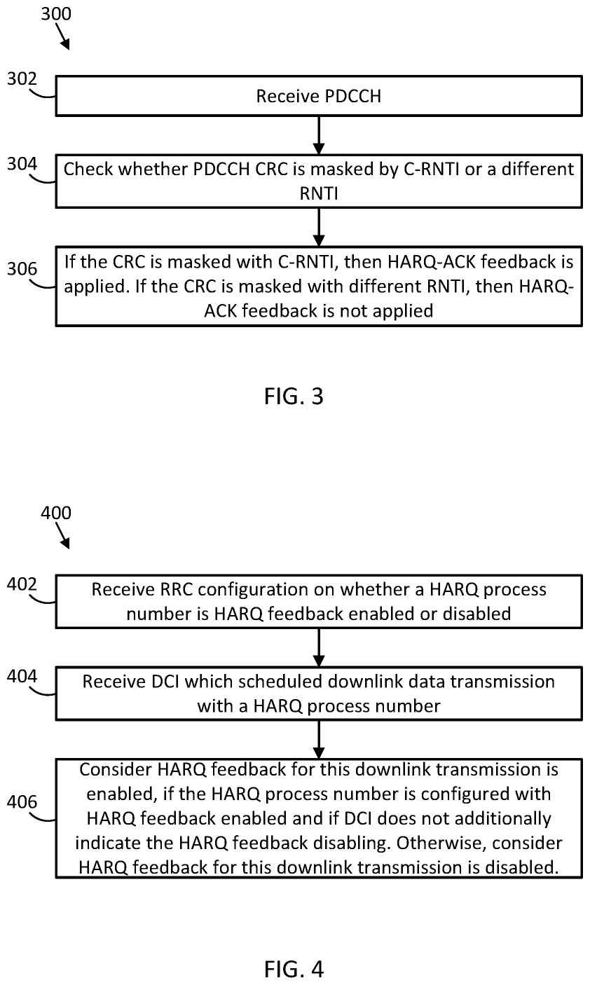

FIG. 3 illustrates an example procedure 300 for dynamic disabling per DCI using an RNTI to indicate whether HARQ feedback is to be disabled in accordance with some embodiments. In particular, the procedure 300 presents operations that may be performed by a UE (such as the UE 104 (FIG. 1)) based on a control transmission received from a base station (such as the base station 102 (FIG. 1)) with the dynamic disabling per DCI with an RNTI to indicate whether HARQ feedback is to be disabled.

The procedure 300 may include receiving PDCCH in 302. For example, the UE may receive the control transmission via the PDCCH from the base station. The control transmission may include a DCI (such as the second DCI 208 (FIG. 2)) and a CRC (such as the second CRC 210 (FIG. 2)) corresponding to the DCI.

The procedure 300 may include checking whether PDCCH CRC is masked by C-RNTI or a different RNTI in 304. For example, the CRC received via the PDCCH may include an RNTI. The UE may determine whether the RNTI included in the CRC is a C-RNTI corresponding to the UE or a RNTI that is different than the C-RNTI.

The procedure 300 may include, if the CRC is masked with the C-RNTI, applying HARQ-ACK feedback or, if the CRC is masked with a different RNTI than the C-RNTI, not applying HARQ-ACK feedback. For example, the UE may determine whether HARQ feedback (also referred to as HARQ-ACK feedback) is enabled or disabled based on the RNTI determination of 304. If the UE determines that the CRC includes (also referred to as being masked with) the C-RNTI in 304, the UE may determine that HARQ feedback is to be enabled for a corresponding HARQ process. If the UE determines that the CRC includes a different RNTI than the C-RNTI, the UE may determine that the HARQ feedback is to be disabled for a corresponding HARQ process.

Alternative 3: Hybrid signaling. Enabled by RRC configuration per HARQ process number. For RRC configuration enabled HARQ process numbers, dynamically disabling via DCI is supported. For example, an RRC configuration provided by the base station 102 to the UE 104 may indicate which HARQ process is to be toggled between being HARQ feedback enabled and HARQ feedback disabled. The base station 102 may then transmit a DCI transmission 108 to the UE 104 to toggle between HARQ feedback enabled and HARQ feedback disabled. In some embodiments, the UE 104 may continue to operate with HARQ feedback disabled once disabled until the base station 102 transmits another DCI transmission that indicated that HARQ feedback is to be enabled. In other embodiments, the UE may operate with HARQ feedback disabled for a HARQ process corresponding to the DCI transmission and may toggle back to HARQ feedback enabled upon completion of the HARQ process. Option 3: UE procedure of determining whether HARQ feedback for the current downlink data transmission is enabled or disabled.

FIG. 4 illustrates an example procedure 400 of hybrid signaling operation in accordance with some embodiments. In particular, the procedure 400 presents operations that may be performed by a UE (such as the UE 104 (FIG. 1)) based on hybrid signaling provided by a base station.

The procedure 400 may include receiving RRC configuration on whether a HARQ process number is HARQ feedback enabled or disabled in 402. For example, the base station may transmit an RRC configuration to the UE that indicates a HARQ process number for a HARQ process for which HARQ feedback is to be enabled or disabled. In some embodiments, the RRC configuration may further indicate whether the HARQ feedback is to be enabled or disabled for the HARQ process based on the RRC configuration. For the description of the procedure 400, the RRC configuration may have indicated that the HARQ feedback is enabled for the HARQ process based on the RRC configuration in 402.

The procedure 400 may include receiving DCI which scheduled downlink data transmission with a HARQ process number. For example, the UE may receive DCI from the base station. The DCI may schedule downlink data transmission with a HARQ process number. The HARQ process number may be the same HARQ process number as the HARQ process number in the RRC configuration in 402 in some instances.

The procedure 400 may include considering HARQ feedback for the downlink transmission is enabled if the HARQ process number is configured with HARQ feedback enabled and if DCI does not additionally indicate the HARQ feedback disabling in 406. Otherwise, the procedure 400 may include considering HARQ feedback for the downlink transmission is disabled in 406. For example, the UE may be scheduled to perform a HARQ process corresponding to the HARQ process number provided in the RRC configuration and/or the DCI. The UE may determine based on the RRC configuration and/or the DCI whether HARQ feedback is to be enabled or disabled. For example, the UE may initially determine whether HARQ feedback is to be enabled or disabled for the HARQ process based on the RRC configuration. The UE may then determine whether DCI has been received that indicates whether HARQ feedback is to be enabled or disabled for the HARQ process or whether HARQ feedback is to be changed from the HARQ feedback indication provided in the RRC configuration. If UE determines that the RRC configuration has indicated that HARQ feedback is to be enabled for the HARQ process and DCI indicating that HARQ feedback is to be disabled for the HARQ process has not been received, the UE may determine that HARQ feedback for the downlink transmission is to be enabled. If the UE determines that the RRC configuration has indicated that HARQ feedback is to be disabled for the HARQ process and DCI indicating that HARQ feedback is to be enabled for the HARQ process has not been received, the UE may determine that HARQ feedback for the downlink transmission is to be disabled. If the UE determines that DCI indicating that HARQ feedback is to be enabled or disabled has been received for the HARQ process, the UE may determine whether HARQ feedback for the downlink transmission is to be enabled or disabled based on the indication from the DCI.

### Approach 2: HARQ-ACK Reporting

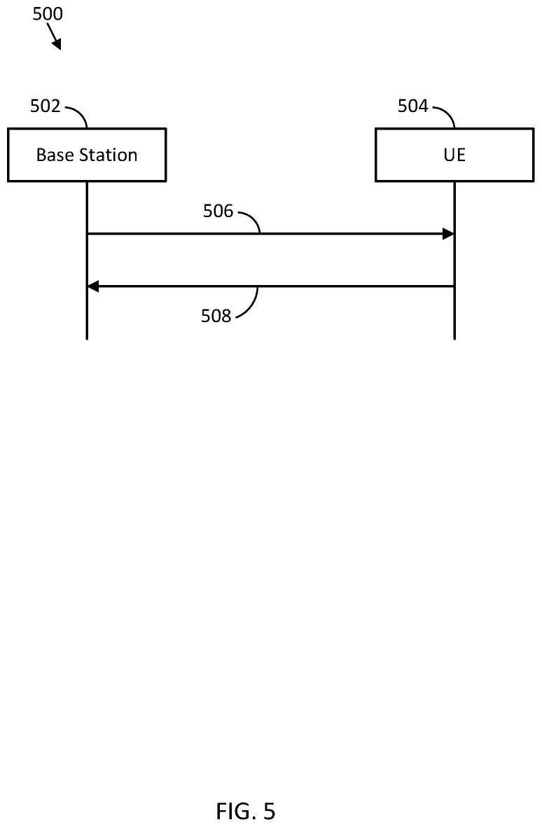

Approach 2: HARQ-ACK reporting. In particular, a UE (such as the UE 104 (FIG. 1)) may report HARQ-ACK to a base station (such as the base station 102 (FIG. 1)). FIG. 5 illustrates a signal chart 500 of HARQ-ACK reporting in accordance with some embodiments.

The signal chart 500 includes a base station 502. The base station 502 may include one or more of the features of the base station 102 (FIG. 1). The base station 502 may be part of an NTN serving IoT UEs.

The signal chart 500 further includes a UE 504. The UE 504 may include one or more of the features of the UE 104 (FIG. 1). The UE 504 may be operating as part of an IoT NTN. For example, the base station 502 may be serving the UE 504 as part of an IoT NTN in the illustrated embodiment.

The base station 502 may transmit a control transmission 506 to UE 504. The control transmission 506 may indicate whether HARQ feedback is to be disabled for communications between the UE 504 and the base station 502. In embodiments, the control transmission 506 may include any of the features and/or embodiments of approach 1 described above.

The UE 504 may receive the control transmission 506 and perform a HARQ process related to the control transmission 506. The UE 504 may generate an uplink transmission 508 based on the control transmission 506. For example, the UE 504 may generate the uplink transmission 508 based on whether the control transmission 506 indicates that the HARQ feedback is to be enabled or disabled. The uplink transmission 508 may include one or more of the features of approach 2 (including approach 2-1 and/or approach 2-2).

Approach 2-1: Dynamic HARQ-ACK codebook construction. For example, a HARQ-ACK codebook construction for feedback from the UE to the base station may be dynamic depending on whether the HARQ feedback is to be enabled or disabled, Dynamic HARQ-ACK codebook construction may be implemented for physical uplink control channel (PUCCH) format 3 or 4 or 5. Configuration of codebooksizeDetermination-r13=dai or codebooksizeDeterminationSTTI=dai. For example, the dynamic HARQ-ACK codebook construction may affect the codebooksizeDetermination-r13=dai or codebooksizeDeterminationSTTI=dai.

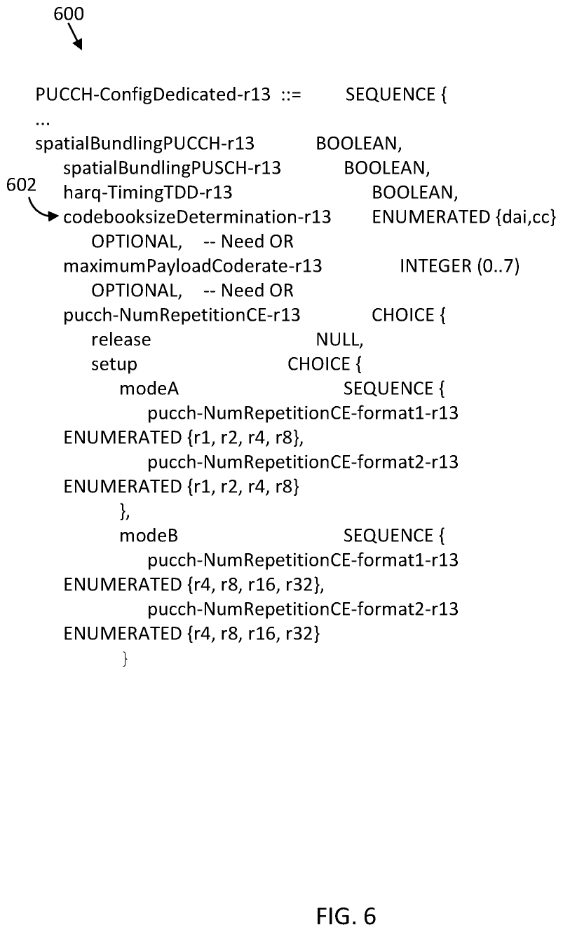

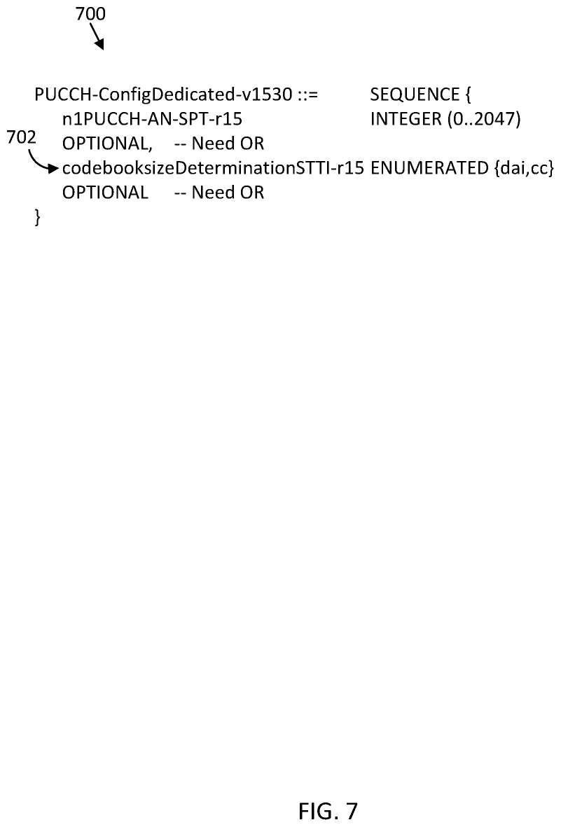

FIG. 6 illustrates an example information element 600 that includes codebooksizeDetermination-r13 602 in accordance with some embodiments. The codebooksizeDetermination-r13 602 may differ based on whether the HARQ feedback is enabled or disabled. FIG. 7 illustrates an example information element 700 that includes codebooksizeDeterminationSTTI 702 in accordance with some embodiments. The codebooksizeDeterminationSTTI 702 may differ based on whether the HARQ feedback is enabled or disabled.

If the HARQ process is configured with feedback enabled, the HARQ codebook includes the corresponding bits. For example, a control transmission (such as the control transmission 506) may indicate that HARQ feedback is to be enabled for the HARQ process. A UE (such as the UE 504) may determine that the HARQ feedback is to be enabled for the HARQ process based on the control transmission. The UE may generate an uplink transmission (such as the uplink transmission 508) with a HARQ codebook that includes bits corresponding to the HARQ feedback for the HARQ process. Therefore, the codebooksizeDetermination-r13 and/or the codebooksizeDeterminationSTTI may include bits corresponding to the HARQ feedback for the HARQ process in this instance.

Alternative 1: If the HARQ process is configured with feedback disabled, the HARQ codebook does not include the corresponding bits. For example, a control transmission (such as the control transmission 506) may indicate that HARQ feedback is to be disabled for the HARQ process. A UE (such as the UE 504) may determine that the HARQ feedback is to be disabled for the HARQ process based on the control transmission. The UE may generate an uplink transmission (such as the uplink transmission 508) with a HARQ codebook that does not include bits corresponding to the HARQ feedback for the HARQ process. Therefore, the codebooksizeDetermination-r13 and/or the codebooksizeDeterminationSTTI may omit bits corresponding to the HARQ feedback for the HARQ process in this instance.

Third Generation Partnership Project (3GPP) Technical Specification (TS) 36.213 referring to 3^{rd} Generation Partnership Project; Technical Specification Group Radio Access Network; Evolved Universal Terrestrial Radio Access (E-UTRA); Physical layer procedures (referred to herein as “TS 36.213”) may define the dynamic HARQ-ACK codebook construction of alternative 1. TS 36.213 Section 7.3.1:
while s<S
while c<N^{DL}_{cells}
   If there is a PDSCH providing a transport block (TB) for a HARQ process with enabled HARQ-ACK information on serving cell c associated with PDCCH/enhanced physical downlink control channel (EPDCCH)/short physical downlink control channel (SPDCCH) or there is a PDCCH/EPDCCH/SPDCCH indicating downlink SPS release on serving cell c for which HARQ-ACK is transmitted in subframe/slot/subslot n, or . . .

In particular, the section of TS 36.213 may indicate that the section is for a TB for a HARQ process with enabled HARQ-ACK information. In TS 36.213 Section 7.3.1, s is sub-slot index, S may be set to 3 for subslot PDSCH operation with higher layer parameter dl-TTI-Length=‘subslot’ and ul-TTI-Length=‘slot’ or 2 for subframe-PDSCH operation with the higher layer parameter shortProcessingTime configured or 1 otherwise, c is cell index, and N^{DL}_{cells} may be set to the number of cells configured by higher layers for the UE.

Alternative 2: if the HARQ process is configured with feedback disabled, the corresponding HARQ bit is always NACK. For example, a control transmission (such as the control transmission 506) may indicate that HARQ feedback is to be disabled for the HARQ process. A UE (such as the UE 504) may determine that the HARQ feedback is to be disabled for the HARQ process based on the control transmission. The UE may generate an uplink transmission (such as the uplink transmission 508) with a HARQ codebook with the HARQ feedback set to NACK for the HARQ process. Therefore, the codebooksizeDetermination-r13 and/or the codebooksizeDeterminationSTTI may have a value of NACK corresponding to the HARQ feedback for the HARQ process in this instance.

For HARQ-ACK bundling case (HARQ with transmission time interval (TTI) bundling): For half-duplex frequency division duplex (FDD) operation with “ce-HARQ-AckBundling” configured and “HARQ-ACK bundling flag” set to 1 in corresponding DCI. Overall principle: If some HARQ processes in the “HARQ with TTI bundling” have disabled feedback, while some HARQ processes in the HARQ with TTI bundling have enabled feedback, the HARQ-ACK bit corresponding to the HARQ processes with disabled feedback is considered as ACK, which implies not affecting the final logical AND operation.

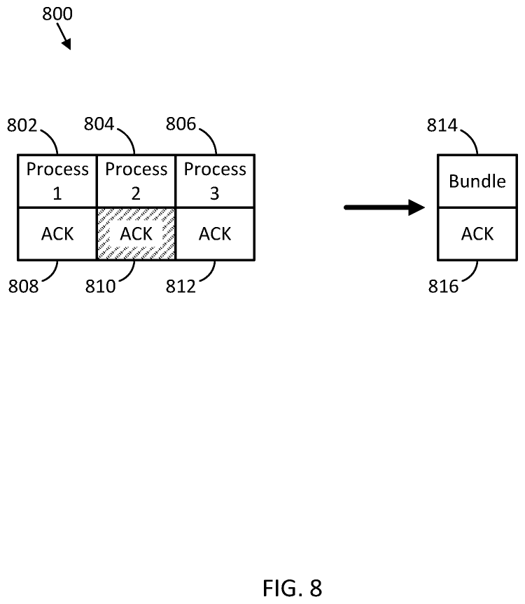

FIG. 8 illustrates an example diagram 800 showing the HARQ-ACK bundling case with a portion of the HARQ processes having HARQ feedback disabled in accordance with some embodiments. In particular, the diagram 800 illustrates HARQ-ACK bundling of HARQ feedback for a plurality of HARQ processes where a portion of the HARQ processes have HARQ feedback disabled. The HARQ-ACK bundling may be performed by a UE (such as the UE 104 (FIG. 1) and/or the UE 504 (FIG. 5)) and the UE may provide a HARQ-ACK value to a base station (such as the base station 102 (FIG. 1) and/or the base station 502 (FIG. 5)) based on the HARQ-ACK bundling.

The diagram 800 illustrates a first HARQ process 802, a second HARQ process 804, and a third HARQ process 806 representations for a HARQ bundling. For example, HARQ-ACK feedback for the first HARQ process 802, the second HARQ process 804, and the third HARQ process 806 may be bundled together. The UE may perform a logical AND on the HARQ feedback for the first HARQ process 802, the second HARQ process 804, and the third HARQ process 806 to produce a HARQ-ACK feedback to be provided to the base station.

Each of the first HARQ process 802, the second HARQ process 804, and the third HARQ process 806 may be configured to produce an ACK or a NACK based on the performance of the HARQ processes and/or the configuration of HARQ feedback as enabled or disabled. Further, a portion of the first HARQ process 802, the second HARQ process 804, and the third HARQ process 806 may be configured with HARQ feedback enabled and another portion of the first HARQ process 802, the second HARQ process 804 and the third HARQ process 806 may be configured with HARQ feedback disabled. The configuring of the HARQ processes as enabled or disabled may be performed by any of the signaling of disabling HARQ feedback described in relation to approach 1 in some embodiments. In the illustrated embodiment of the diagram, the first HARQ process 802 and the third HARQ process 806 are configured with HARQ feedback enabled, while the second HARQ process 804 is configured with HARQ feedback disabled.

Each of the first HARQ process 802, the second HARQ process 804, and the third HARQ process 806 may produce an ACK/NACK value based on the result of the HARQ process and/or the configuration of HARQ feedback as enabled or disabled. In the illustrated embodiment, a first value 808 may be generated corresponding to the first HARQ process 802, a second value 810 may be generated corresponding to the second HARQ process 804, and a third value 812 may be generated corresponding to the third HARQ process 806. As the first HARQ process 802 and the third HARQ process 806 are configured with HARQ feedback enabled, the first value 808 corresponding to the first HARQ process 802 may be generated based on the result of the first HARQ process 802 and the third value 812 corresponding to the third HARQ process 806 may be generated based on the result of the third HARQ process 806. In the illustrated embodiment, the first value 808 may be generated as ACK and the third value 812 may be generated as ACK. As the second HARQ process 804 are configured with HARQ feedback disabled, the second value 810 may be generated based on the HARQ feedback being disabled for the second HARQ process 804, as indicated by the diagonal line fill of the box corresponding to the second value 810. Due to the HARQ feedback being disabled for the second HARQ process 804, the second value 810 corresponding to the second HARQ process 804 may be automatically set to a value of ACK.

The UE may then combine the values corresponding to the first HARQ process 802, the second HARQ process 804, and the third HARQ process 806 to produce a value 816 for the HARQ-ACK bundle 814. For example, the HARQ-ACK bundle 814 may comprise a bundle including the first HARQ process 802, the second HARQ process 804, and the third HARQ process 806. The values corresponding to the HARQ processes may have logical AND applied to produce the value 816 for the HARQ-ACK bundle 814. In the illustrated example, a logical AND operation may be applied to the first value 808, the second value 810, and the third value 812 to produce the value 816. Accordingly, the first value 808 of ACK, the second value 810 of ACK, and the third value 812 of ACK may produce a value 816 of ACK or the HARQ-ACK bundle 814. As will be understood by one having ordinary skill in the art, the second value 810 being automatically set to ACK based on the HARQ feedback being disabled causes the value 816 to be dependent on the first value 808 and the third value 812. The UE may then transmit the value 816 to the base station to indicate the value of the bundle. For example, the value 816 may be transmitted in the uplink transmission 508 from the UE 504 to the base station 502 in some embodiments.

While the diagram 800 is shown with three HARQ processes being bundled, it should be understood that more or less HARQ processes may be bundled in other embodiments.

If all HARQ processes in the “HARQ with TTI bundling” have disabled feedback, some alternatives may be applied. Alternative 1: The HARQ-ACK bit is omitted. Alternative 2: The HARQ-ACK bit is ACK. Alternative 3: The HARQ-ACK bit is NACK. For example, if the first HARQ process 802, the second HARQ process 804, and the third HARQ process 806 in the diagram 800 all have HARQ feedback disabled, the value 816 may be set or omitted in accordance with the three alternatives. In particular, in alternative 1 with the first HARQ process 802, the second HARQ process 804, and the third HARQ process 806 having HARQ feedback disabled, the value 816 for the bundle 814 may be omitted in the transmission from the UE to the base station. In alternative 2 with the first HARQ process 802, the second HARQ process 804, and the third HARQ process 806 having HARQ feedback disabled, the value 816 for the bundle 814 may be set to ACK. In alternative 3 with the first HARQ process 802, the second HARQ process 804, and the third HARQ process 806 having HARQ feedback disabled, the value 816 for the bundle 814 may be set to NACK.

TS 36.213 Section 7.3.1 may embody the dynamic HARQ-ACK codebook construction of approach 2-1. TS 36.213 Section 7.3.1:
for HARQ-ACK transmission in subframe n, the UE shall generate one HARQ-ACK bit by performing a logical AND operation of HARQ-ACKs across all 1≤M≤4 bandwidth reduced low complexity (BL)/coverage enhancement (CE) DL subframes for which subframe n is the ‘HARQ-ACK transmission subframe’, where the HARQ-ACK bit corresponding to the HARQ process with feedback disabled is not counted (or is counted as ACK).
If all the HARQ-ACKs across all 1≤M≤4 BL/CE DL subframes are associated with HARQ processes with feedback disabled, the corresponding one HARQ-ACK bit is
   Alternative 1: omitted (i.e., no HARQ feedback)
   Alternative 2: ACK
   Alternative 3: NACK

For example, TS 36.213 Section 7.3.1 illustrated above may state that the HARQ-ACK bit corresponding to the HARQ process with feedback disabled is not counted in some embodiments or is counted as ACK in some other embodiments. Further, TS 36.213 Section 7.3.1 may stat that if all HARQ-ACKs associated with HARQ processes have feedback disabled, the corresponding HARQ-ACK bit may be omitted in some embodiments, may be set to ACK in some embodiments, or may be set to NACK in some embodiments.

Approach 2-2: HARQ-ACK reporting with channel selection. HARQ-ACK reporting may be applicable to both FDD and time division duplex (TDD). Further, the HARQ-ACK reporting with channel selection may be applicable to PUCCH format 1b with more than 1 configured serving cell. In some of the serving cells, the scheduled HARQ process is configured with disabled HARQ feedback. In some of the serving cells, the scheduled HARQ process is configured with enabled HARQ feedback.

HARQ-ACK multiplexing case with channel selection. Overall principle: If the scheduled HARQ process on a serving cell has disabled HARQ feedback, alternative 1: The corresponding HARQ-ACK feedback is always NACK. Alternative 2: The corresponding HARQ-ACK feedback is always ACK. Alternative 1 and Alternative 2 could simplify evolved nodeB's (eNB's) (which may also be referred to as “base station's”) receiving of PUCCH format 1b. Alternative 3: The corresponding HARQ-ACK feedback is ACK or NACK, depending on the corresponding PDSCH decoding results. In the alternative 3, it does not matter (same behavior) whether the scheduled HARQ process has disabled HARQ feedback.

For example, in instances where HARQ-ACK multiplexing with channel selection has been implemented, the UE may return a defined value for a scheduled HARQ process having disabled HARQ feedback. In alternative 1, the UE 504 may transmit the uplink transmission 508 with a value of NACK for the corresponding HARQ-ACK feedback for the HARQ process having HARQ feedback disabled. In alternative 2, the UE 504 may transmit the uplink transmission 508 with a value of ACK for the corresponding HARQ-ACK feedback for the HARQ process having HARQ feedback disabled. In alternative 3, the UE 504 may determine the corresponding PDSCH decoding results corresponding to the HARQ process. Based on the PDSCH decoding results, the UE 504 may transmit the uplink transmission 508 with a value of ACK or NACK depending on the PDSCH decoding results.

In Alt 1, 2, 3, the mapping tables (e.g., Tables 10.1.2.2.1-3, 10.1.2.2.1-4, 10.1.2.2.1-5 of TS 36.213) are unchanged. For example, the mapping tables for HARQ-ACK channel selection of TS 36.213 may be unchanged from the legacy mapping tables.

Alternative 4: The corresponding HARQ-ACK feedback for feedback disabled HARQ process is omitted. The number of HARQ-ACK feedback bits is reduced. The mapping tables with reduced A number is used. For example, the uplink transmission 508 transmitted by the UE 504 to the base station 502 may omit HARQ-ACK feedback for a HARQ process where HARQ feedback has been disabled. Accordingly, a number of HARQ-ACK feedback bits within the uplink transmission 508 may be reduced based on the HARQ-ACK feedback being omitted for the HARQ process.

Special case: all the scheduled HARQ processes on all the configured serving cells have disabled HARQ feedback. Alternative 1: UE does not need to send HARQ feedback at all. Alternative 2: UE still needs to send HARQ feedback, with corresponding values of either NACK or discontinuous reception (DTX), depending DCI decoding results. For example, if all the HARQ processes scheduled on the configured serving cells have HARQ feedback disabled, the UE 504 may omit the HARQ feedback from the uplink transmission 508 in alternative 1. In alternative 2, the UE 504 may determine the DCI decoding results. Based on the DCI decoding results, the UE 504 may transmit the message with corresponding values of NACK or DTX for the HARQ processes with HARQ feedback disabled in accordance with the DCI decoding results.

### Approach 3: SPS PDSCH

Approach 3: SPS PDSCH

SPS configuration. Alternative 1: Same as the per HARQ process configuration of approach 1. Network implementation to ensure all the HARQ processes in a SPS configuration have the same feedback setting. For example, the SPS configuration may utilize the signaling illustrated by the signal chart 100 (FIG. 1). The base station 102 (FIG. 1) may perform SPS configuration in configuring the UE 104 (FIG. 1). The base station 102 may transmit the control transmission 106 (FIG. 1) to configure the UE 104. For alternative 1, the control transmission 106 for the SPS configuration may include one or more of the features of approach 1, including alternative 1 through alternative 3 of approach 1. For example, the control transmission 106 may include a HARQ process number, and indicate whether the HARQ feedback is to be enabled or disabled for a HARQ process corresponding to the HARQ process number or indicate a HARQ process number corresponding to a HARQ process that may be enabled or disabled by RRC and/or DCI in some embodiments such as in approach 1, alternative 1 and alternative 3. In some embodiments, an RNTI may be utilized to make a CRC corresponding to a DCI scheduling a HARQ process to indicate whether the HARQ process is to have HARQ feedback disabled such as in approach 1, alternative 2.

Alternative 2: Separate configuration in SPS-Config. For example, SPS-ConfigDL (or SPS-ConfigUL) has a single bit to indicate whether feedback is enabled or disabled for all the HARQ processes in the SPS configuration. For example, the control transmission 106 transmitted by the base station 102 to the UE 104 may include SPS-ConfigDL or SPS-ConfigUL information elements. The SPS-ConfigDL or SPS-ConfigUL in the control transmission 106 may include one or more bits to indicate whether HARQ feedback is to be enabled or disabled for all HARQ processes in a SPS configuration.

SPS release: always have the HARQ feedback since it is not associated with HARQ process number. For example, SPS release operations may always have HARQ feedback enabled. Accordingly, the base station 102 may not include an indication of whether HARQ feedback is enabled or disabled for SPS release operations in the control transmission 106 in some embodiments.

SPS activation: Alternative 1: RRC configuration to indicate whether HARQ feedback is enabled/disabled for SPS activation. If enabled, UE reports ACK/NACK (depending on the first SPS PDSCH decoding results) for the first SPS PDSCH after activation, regardless of whether HARQ feedback is enabled or disabled for the HARQ process associated with SPS PDSCH. If disabled, UE reports ACK/NACK (depending on the first SPS PDSCH decoding results) if the first SPS PDSCH after activation is associated with a HARQ process with feedback enabled. Or, UE does not report HARQ if the first SPS PDSCH after activation is associated with a HARQ process with feedback disabled.

For example, the control transmission 106 transmitted by the base station 102 to the UE 104 may be an RRC configuration transmission. The RRC configuration transmission may indicate whether HARQ feedback is enabled or disabled for an SPS activation. The UE 104 may then report values ACK or NACK for the SPS PDSCH after the SPS activation in an uplink transmission (such as the uplink transmission 508 (FIG. 5)). The UE 104 may determine whether the HARQ feedback is to be enabled or disabled for the SPS activation based on the RRC configuration transmission received from the base station 102.

If the UE 104 determines that the HARQ feedback is enabled for the SPS activation, the UE 104 may report ACK or NACK for the first SPS PDSCH after the SPS activation, where the ACK or NACK may be determined based on the first SPS PDSCH coding results. For this instance where the HARQ feedback is enabled for the SPS activation, the UE 104 may provide the ACK/NACK regardless of whether the HARQ feedback is enabled or disabled for the HARQ process associated with the SPS PDSCH.

If the UE 104 determines that the HARQ feedback is disabled for the SPS activation, the UE 104 may determine whether the first SPS PDSCH after the SPS activation is associated with a HARQ process that has HARQ feedback enabled or disabled. If the UE 104 determines that the first SPS PDSCH is associated with a HARQ process that has HARQ feedback enabled, the UE 104 may provide the ACK or NACK for the first SPS PDSCH, where the ACK or NACK may be determined based on the first SPS PDSCH decoding results. If the UE 104 determines that the first SPS PDSCH is associated with a HARQ process that has HARQ feedback disabled, the UE 104 may omit reporting the HARQ feedback.

Alternative 2: Depend on the per HARQ process configuration for the HARQ process in the first SPS PDSCH. UE reports ACK/NACK (depending on the first SPS PDSCH decoding results) if the first SPS PDSCH after activation is associated with a HARQ process with feedback enabled. Or, UE does not report HARQ if the first SPS PDSCH after activation is associated with a HARQ process with feedback disabled.

For example, the UE 104 may determine whether the HARQ process in the first SPS PDSCH after the SPS activation is associated with a HARQ process with HARQ feedback enabled or disabled. If the UE 104 determines that the HARQ process has HARQ feedback enabled, the UE 104 may report (such as in the uplink transmission 508) ACK or NACK for the first SPS PDSCH to the base station 102, where the ACK or NACK is determined based on the first SPS PDSCH decoding results. If the UE 104 determines that the HARQ process has HARQ feedback disabled, the UE 104 may omit HARQ feedback corresponding to the first SPS PDSCH in the response to the base station 102.

Alternative 3: Depend on the SPS configuration. If SPS is configured with all HARQ processes with HARQ feedback enabled, then UE reports ACK/NACK as in legacy way. If SPS is configured with all HARQ processes with HARQ feedback disabled, then UE does not report ACK/NACK.

For example, the UE 104 may determine whether the SPS configuration configures all the HARQ processes with HARQ feedback enabled or HARQ feedback disabled. If the UE 104 determines that all the HARQ processes are configured with HARQ feedback enabled, the UE 104 may report (such as in the uplink transmission 508) to the base station 102 (FIG. 1) ACK or NACK in accordance with legacy approaches, where the ACK or NACK may be determined on the results of the HARQ processes. If the UE 104 determines that all the HARQ processes are configured with HARQ feedback disabled, the UE 104 may omit reporting HARQ feedback to the base station 102.

SPS PDSCH. Alternative 1: Always report NACK if the corresponding HARQ process in SPS configuration has disabled feedback Alternative 2: Does not report ACK/NACK if the corresponding HARQ process in SPS configuration has disabled feedback.

For example, the UE 104 may determine whether a HARQ process corresponding to a SPS PDSCH transmission configured with SPS configuration has HARQ feedback disabled. In alternative 1, if UE 104 determines that the HARQ process has HARQ feedback disabled, the UE 104 may report (such as in the uplink transmission 508) NACK for the HARQ process to the base station 102. In alternative 2, if the UE 104 determines that the HARQ process has HARQ feedback disabled, the UE 104 may omit reporting HARQ feedback to the base station 102.

### TS 36.213 Section 7.3.1:

if SPS PDSCH transmission is activated for a UE and the UE is configured to receive SPS PDSCH in subframe/slot n−4 or in subslot n−Xₚ and the SPS PDSCH providing a transport block (TB) for a HARQ process with enabled HARQ-ACK information

$$\begin{matrix}{O}^{ACK} = {O}^{ACK} + 1 \\ {o}_{{O}^{ACK} - 1}^{ACK} = HARQ - ACK bit asssociated with the SPS PDSCH transmission end if\end{matrix}$$

TS 36.213 section 7.3.1 may reflect the HARQ disablement approach for SPS PDSCH for alternative 2. For example, the TS 36.213 may state that the SPS PDSCH providing a TB for a HARQ process with enabled HARQ-ACK information is defined for HARQ feedback to be provided.

Approach 4: PDSCH processing timeline. The PDSCH processing timeline approach may relate to times where a UE may expect to receive a PDCCH transmission or a PDSCH transmission after receiving a PDSCH transmission. For example, the UE may not monitor for, may ignore, or may indicate an error for PDCCH transmissions received within a time period of a PDSCH transmission or PDSCH transmissions received within a time period of a PDSCH transmission in some embodiments. In some embodiments, a base station may be limited to scheduling PDCCH transmissions to a UE to at least a certain time period after the base station has transmitted a PDSCH transmission to the UE or may be limited to scheduling PDSCH transmissions to a UE to at least a certain time period after the base station has transmitted a PDSCH transmission to the UE.

Alternative 1: UE is not expected to receive another PDCCH carrying the DCI scheduling another PDSCH for a given HARQ process number with disabled HARQ feedback, T_{proc,1} from the end of the reception of the last PDSCH for the same HARQ process number.

Alternative 2: UE is not expected to receive another PDSCH of a given HARQ process number with disabled HARQ feedback, T_{proc,2} from the end of the reception of the last PDSCH for the same HARQ process number.

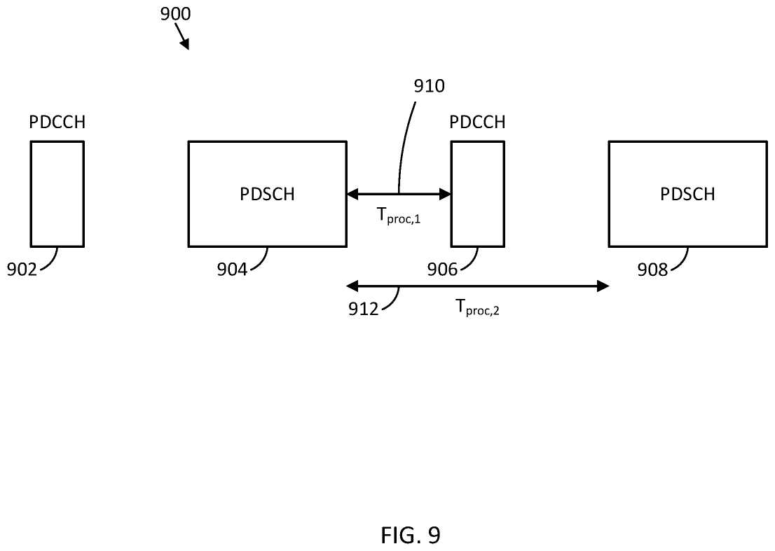

FIG. 9 illustrates a PDSCH timing representation 900 in accordance with some embodiments. In particular, the timing representation 900 may represent the PDSCH processing timeline for approach 4, including alternative 1 and alternative 2.

The timing representation 900 may include a first PDCCH transmission 902 and a first PDSCH transmission 904. The first PDCCH transmission 902 and the first PDSCH transmission 904 may be transmitted by a base station (such as the base station 102 (FIG. 1) and/or the base station 502 (FIG. 5)) to a UE (such as the UE 104 (FIG. 1) and/or the UE 504 (FIG. 5)). The first PDSCH transmission 904 may correspond to the first PDCCH transmission 902, such as the first PDCCH transmission 902 scheduling the first PDSCH transmission 904. The UE may detect reception of the first PDCCH transmission 902 and the first PDSCH transmission 904.

The timing representation 900 may include a first timing procedure period 910. The first timing procedure period 910 may relate to alternative 1 of approach 4. In particular, the first timing procedure period 910 may indicate an amount of time after the first PDSCH transmission 904 for which the UE is not expected to receive another PDCCH transmission. In the illustrated embodiment, the first timing procedure period 910 is shown measuring from the end of the first PDSCH transmission 904, although it should be understood that first timing procedure period 910 may measure from a different event of the first PDSCH transmission 904 (such as the beginning of the first PDSCH transmission 904). In some embodiments, the UE may not monitor for, may ignore, or may indicate an error for PDCCH transmissions received during the first timing procedure period 910. The UE may begin to monitor for further PDCCH transmissions once the first timing procedure period 910 has expired. In some embodiments, the base station may be prevented from transmitting a further PDCCH transmission until expiration of the first timing procedure period 910. The timing representation 900 may further include a second PDCCH transmission 906 illustrated at the expiration of the first timing procedure period 910. The UE may detect the second PDCCH transmission 906 (or other PDCCH transmissions scheduled after the time of the second PDCCH transmission 906) based on the second PDCCH transmission 906 arriving at the UE after the expiration of the timing procedure period from the previous PDSCH transmission, which is the first PDSCH transmission 904 in the illustrated embodiment.

The timing representation 900 may include a second timing procedure period 912. The second timing procedure period 912 may relate to alternative 2 of approach 4. In particular, the second timing procedure period 912 may indicate an amount of time after the first PDSCH transmission 904 for which the UE is not expected to receive another PDSCH transmission. In the illustrated embodiments, the second timing procedure period 912 is shown measuring from the end of the first PDSCH transmission 904, although it should be understood that second timing procedure period 912 may measure from a different event of the first PDSCH transmission 904 (such as the beginning of the first PDSCH transmission 904). In some embodiments, the UE may not monitor for, may ignore, or may indicate an error for PDSCH transmissions received during the second timing procedure period 912. The UE may begin to monitor for further PDSCH transmissions once the second timing procedure period 912 has expired. In some embodiments, the base station may be prevented from transmitting a further PDSCH transmission until expiration of the second timing procedure period 912. The timing representation 900 may further include a second PDSCH transmission 908 illustrated at the expiration of the second timing procedure period 912. The UE may detect the second PDSCH transmission 908 (or other PDCCH transmissions scheduled after the time of the second PDSCH transmission 908) based on the second PDSCH transmission 908 arriving at the UE after the expiration of the timing procedure period from the previous PDSCH transmission, which is the first PDSCH transmission 904 in the illustrated embodiment.

Both Alternative 1 and Alternative 2 may be applied simultaneously. First timing procedure period (T_{proc,1}) and second timing procedure period (T_{proc,2}) may depend on UE capability. The PDSCH may be repetition of PDSCH: “last PDSCH” becomes “last of PDSCH repetitions”. The PDSCH may be SPS PDSCH. Alternative 2: may be applied to SPS PDSCH, which does not have scheduling DCI.

For example, alternative 1 with the first timing procedure period 910 between the first PDSCH transmission 904 and the second PDCCH transmission 906 and alternative 2 with the second timing procedure period 912 between the first PDSCH transmission 904 and the second PDSCH transmission 908 may be implemented in the same embodiment. For example, the UE may expect any PDCCH transmissions to occur at least the first timing procedure period 910 after the last PDSCH transmission and the UE may expect any PDSCH transmissions to occur at least the second timing procedure period 912 after the last PDSCH transmission in some embodiments. In other embodiments, one of alternative 1 or alternative 2 may be implemented. Further, the first timing procedure period 910 and/or the second timing procedure period 912 may be dependent on a UE capability of a UE implementing the alternatives. For example, a duration of the first timing procedure period 910 and/or a duration of the second timing procedure period 912 may depend on the UE capability of the UE.

In some embodiments, a PDSCH transmission may be repeated. Accordingly, the same PDSCH transmission may be transmitted multiple times in a row. In these instances, the first timing procedure period 910 and/or the second timing procedure period 912 may measure from the last PDSCH transmission in the repetitions of the PDSCH transmission.

In some embodiments, the PDSCH transmission may be an SPS PDSCH transmission. In these embodiments, alternative 2 may be applied to the SPS PDSCH transmission, where the SPS PDSCH transmission does not have scheduling DCI. For example, the first PDSCH transmission 904 may be a SPS PDSCH transmission and the UE may expect the second time procedure period 912 before the second PDSCH transmission 908, which also may be an SPS PDSCH in some embodiments.

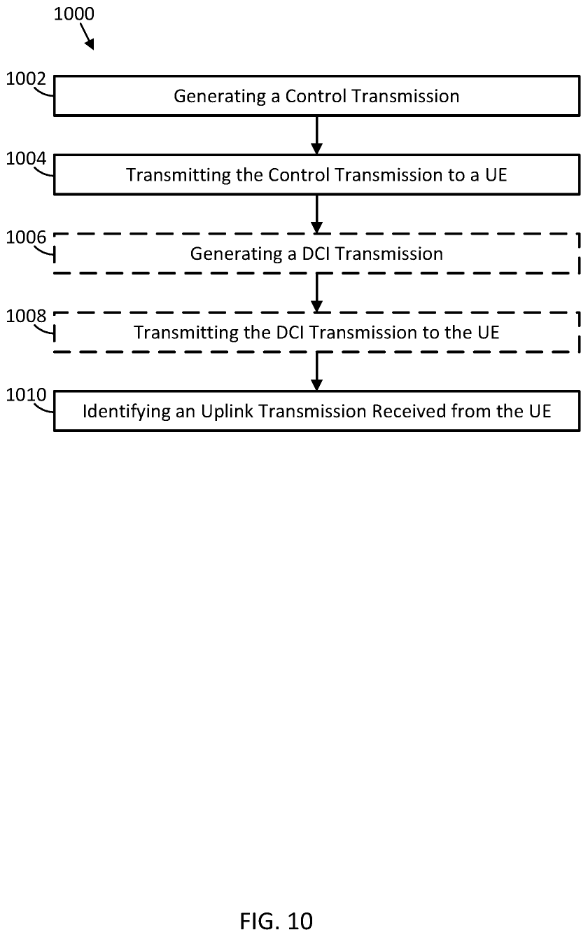

FIG. 10 illustrates an example procedure 1000 of operating a base station in an IoT NTN in accordance with some embodiments. For example, the procedure 1000 may be performed by a base station, such as the base station 102 (FIG. 1), the base station 502 (FIG. 5), the base station 1208 (FIG. 12), the base station 1212 (FIG. 12), and/or the base station 1400 (FIG. 14).

The procedure 1000 may include generating a control transmission in 1002. For example, the base station may generate a control transmission that indicates whether HARQ feedback is to be disabled for a HARQ process within the IoT NTN. In some embodiments, the control transmission may be an RRC transmission. In some embodiments, the control transmission may be a DCI transmission for scheduling the HARQ process. In some of these embodiments where the control transmission is an RRC transmission, the control transmission may be a first control transmission.

The control transmission may include a field indicating whether HARQ feedback is to be enabled or disabled. For example, the control transmission may be an RRC transmission in some embodiments. A PDSCH-ConfigDedicated information element or a PUSCH-ConfigDedicated information element of the RRC transmission includes a field indicating whether the HARQ feedback is to be disabled for the HARQ process related to the RRC transmission. The field may include a HARQ process number corresponding to the HARQ process. In some embodiments, the control transmission may be a DCI transmission for scheduling the HARQ and the DCI transmission may include a field indicating whether the HARQ feedback is to be disabled for the HARQ process in some embodiments. In some of these embodiments, the field may be a one-bit field indicating whether the HARQ feedback is to be disable for the HARQ process.

In some embodiments, the control transmission may include a masking to indicate whether HARQ feedback is to be enabled or disabled. For example, the control transmission may be a DCI transmission for scheduling the HARQ process in some embodiments. A CRC of the DCI transmission may be masked with an RNTI different from a C-RNTI corresponding to a cell of the UE to indicate that the HARQ feedback is to be disabled. The CRC may be unmasked and/or have the C-RNTI for the CRC to indicate that the HARQ feedback is to be enabled.

In some embodiments, the control transmission may be utilized in an SPS instances. For example, the control transmission may be a RRC transmission. The RRC transmission may include a configuration in a SPS-Config information element indicating whether the HARQ feedback is to be disabled for the HARQ process related to the RRC transmission. In some embodiments, the SPS-Config information element may include a single bit indicating whether the HARQ feedback is to be disabled for the HARQ process.

The procedure 1000 may include transmitting the control transmission to a UE in 1004. In particular, the base station may transmit the control transmission generated in 1002 to a UE. The UE may be configured to perform the HARQ process based on the control transmission. Further, the UE may determine whether to provide HARQ feedback for the HARQ process to base station based on the control transmission.

The procedure 1000 may include generating a DCI transmission in 1006. For example, the control transmission generated in 1002 may be a first control transmission in some embodiments, where the first control transmission is a RRC transmission. In these embodiments, the base station may generate a DCI transmission, where the DCI transmission may be a second control transmission. The DCI transmission may further indicate whether the HARQ feedback is to be disabled for the HARQ process. The RRC transmission may include an RRC field indicating whether the HARQ feedback is to be disabled for the HARQ process. The RRC field may include a HARQ process number corresponding to the HARQ process. The DCI transmission may include a DCI field further indicating whether the HARQ feedback is to be disabled for the HARQ process. The DCI field may include the HARQ process number. In some embodiments, 1006 may be omitted.

The procedure 1000 may include transmitting the DCI transmission to the UE in 1008. In particular, the base station may transmit the DCI transmission generated in 1006 to the UE. In some embodiments, 1008 may be omitted.

The procedure 1000 may include identifying an uplink transmission received from the UE in 1010. In particular, the base station may identify an uplink transmission received from the UE corresponding to the control transmission.

While the procedure 1000 is illustrated and described in a particular order, it should be understood that one or more of the operations of the procedure 1000 may be omitted in embodiments. Further, it should be understood that one or more of the operations of the procedure 1000 may be performed concurrently or may be performed in a different order than illustrated and described.

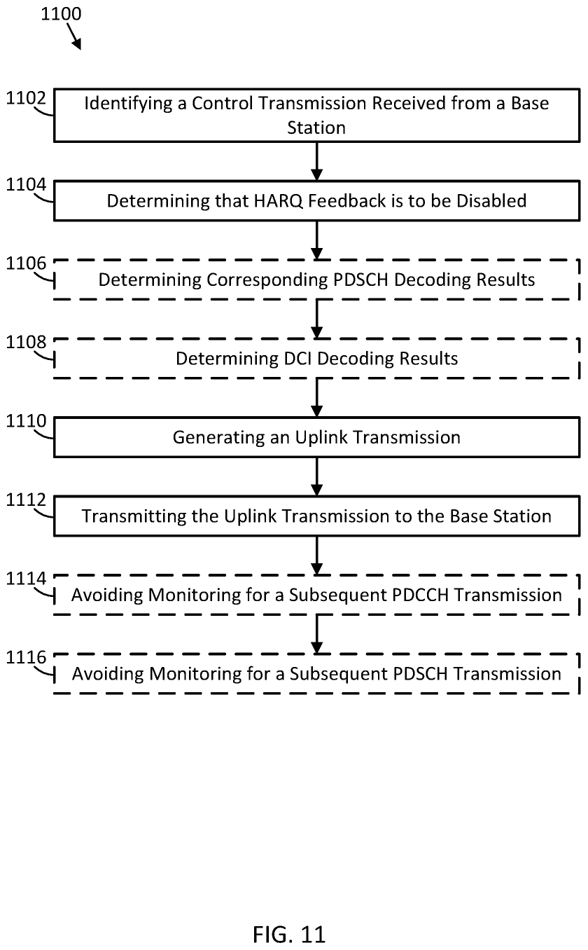

FIG. 11 illustrates an example procedure 1100 of operating a UE in an IoT NTN in accordance with some embodiments. For example, the procedure 1100 may be performed by a UE, such as the UE 104 (FIG. 1), the UE 504 (FIG. 5), the UE 1204 (FIG. 12), the UE 1206 (FIG. 12), and/or the UE 1300 (FIG. 13).

The procedure 1100 may include identifying a control transmission received from a base station in 1102. For example, the UE may identify a control transmission received from a base station of the IoT NTN indicating that HARQ feedback is to be disabled for a HARQ process. In some instances, the control transmission may indicate that all HARQ processes within the HARQ with TTI bundling are to have HARQ feedback disabled. In some other instances, the control transmission may indicate that all scheduled HARQ processes on all of the multiple configured serving cells are to have HARQ feedback disabled. Further, the control transmission may comprise a DCI transmission transmitted via a PDCCH in some instances, the DCI to schedule a PDSCH transmission.

In some embodiments, the HARQ process may be implemented may be part of a bundling or performed on a serving cell of multiple configured serving cells. For example, the HARQ process may be part of a HARQ with TTI bundling in some instances. In other instances, the HARQ process may be performed on a serving cell of multiple configured serving cells.

The procedure 1100 may include determining that the HARQ feedback is to be disabled in 1104. For example, the UE may determine that HARQ feedback is to be disabled for the HARQ process based on the control transmission.

The procedure 1100 may include determining corresponding PDSCH decoding results in 1106. For example, the UE may determine corresponding PDSCH decoding results. In some embodiments, 1106 may be omitted.

The procedure 1100 may include determining DCI decoding results in 1108. For example, the UE may determine downlink decoding results. In some embodiments, 1108 may be omitted.

The procedure 1100 may include generating an uplink transmission in 1110. For example, the UE may include generating an uplink transmission with a HARQ codebook based on the determination that the HARQ feedback is to be disabled for the HARQ process.

In some embodiments, the HARQ codebook may omit or include a particular value for the HARQ process based on the determination that the HARQ feedback is to be disabled for the HARQ process. For example, the HARQ codebook may omit a corresponding bit for the HARQ process based on the determination that the HARQ feedback is to be disabled for the HARQ process in some embodiments. Further, the HARQ codebook may include a NACK for the HARQ process based on the determination that the HARQ feedback is to be disabled for the HARQ process in some embodiments.

In some embodiments, the HARQ codebook may be for the HARQ process that is part of a HARQ TTI bundling. For example, the HARQ information for the HARQ process may be treated as an ACK for determining the HARQ codebook in some embodiments where the HARQ process is part of a HARQ with TTI bundling. In some embodiments, the HARQ codebook may have a HARQ-ACK bit omitted based on all the HARQ processes within the HARQ with TTI bundling having HARQ feedback disabled. Further, the HARQ codebook may have a HARQ-ACK bit value corresponding to ACK based on all the HARQ processes within the HARQ with TTI bundling having HARQ feedback disabled in some embodiments. In some embodiments, the HARQ codebook may have a HARQ-ACK bit value corresponding to NACK based on all the HARQ processes within the HARQ with TTI bundling having HARQ feedback disabled.

In some embodiments, the HARQ process may be performed on a serving cell of multiple configured serving cells. In some embodiments, the HARQ codebook may have a NACK value corresponding to the HARQ process based on a determination that the HARQ feedback is to be disabled for the HARQ process. Further, the HARQ codebook may have an ACK value corresponding to the HARQ process based on a determination that the HARQ feedback is to be disabled for the HARQ process in some embodiments. In some embodiments where the PDSCH decoding results are determined in 1106, the HARQ codebook may have an ACK value or a NACK value based on the PDSCH decoding results. Further, the HARQ feedback for the HARQ process may be omitted from the HARQ codebook in some embodiments.

There may be instances where the control transmission indicates that all scheduled HARQ processes on all of the multiple configured serving cells are to have HARQ feedback disabled. In some of these embodiments, the HARQ feedback may be omitted from the HARQ codebook. In some of these embodiments where DCI decoding results are determined in 1108, the HARQ codebook may include a NACK value or a DTX value for the HARQ process.

The procedure 1100 may include transmitting the uplink transmission in 1112. For example, the UE may transmit the uplink transmission generated in 1110 to the base station.

The procedure 1100 may include avoiding monitoring for a subsequent PDCCH transmission in 1114. For example, the UE may avoid monitoring for a subsequent PDCCH transmission a defined processing time after the PDSCH transmission in some embodiments. This may occur where the control transmission is a DCI transmission transmitted via the PDCCH and the DCI is to schedule a PDSCH transmission. In some embodiments, 1114 may be omitted.

The procedure 1100 may include avoiding monitoring for a subsequent PDSCH transmission in 1116. For example, the UE may avoid monitoring for a subsequent PDSCH transmission for a defined processing time after the PDSCH transmission in some embodiments. This may occur where the control transmission is a DCI transmission transmitted via the PDCCH and the DCI is to schedule a PDSCH transmission. In some embodiments, 1116 may be omitted.

While the procedure 1100 is illustrated and described in a particular order, it should be understood that one or more of the operations of the procedure 1100 may be omitted in embodiments. Further, it should be understood that one or more of the operations of the procedure 1100 may be performed concurrently or may be performed in a different order than illustrated and described.

While the above description describes the approaches and the alternatives separately for clarity, it should be understood that two or more of the approaches and/or two or more of the alternatives may be implemented in a same embodiment. For example, approach 1 that defines operation of a base station and approach 2 that defines operation of a UE may be implemented in a same embodiment. Further, alternative 1 of approach 2-1 related to the dynamic HARQ-ACK codebook construction and alternative 1 of approach 2-1 related to the HARQ-ACK bundling case may be implemented in the same embodiment. Accordingly, it should be understood that each of the embodiments may implement one or more of the approaches and/or one or more of the alternatives, where each the embodiments may include different approaches and/or alternatives.

FIG. 12 illustrates a network environment 1200 in accordance with some embodiments. The network environment 1200 may include a UE 1204, UE 1206, mobile base station (BS) 1208, and mobile BS 1212.

The mobile BSs 1208/1212 may be base stations that are configured to provide radio access cells (or “serving cells”) for geographical locations in the vicinity of the mobile BS. The mobile BSs 1208/1212 may be terrestrial or non-terrestrial base stations that are capable of moving relative to geographical locations, typically on fixed or predetermined routes. For example, the mobile BSs 1208/1212 may be provided by vehicles, trains, unmanned aerial vehicles, airplanes, satellites of various altitude classifications (for example, low-earth orbit, medium-earth orbit, geosynchronous earth orbit, or high-earth orbit), etc.

The UEs 1204/1206 are depicted as mobile phones. However, the UEs 1204/1206 may be any type of user equipment such as computers, tablets, industrial wireless sensors, video surveillance/monitoring devices, wearable devices, vehicles, vehicles equipped with wireless connections, Internet of things (IoT) devices, etc.

The mobile BSs 1208/1212 may be configured to provide stationary serving cells at set geographical locations. For example, the mobile BS 1208 may initially provide a serving cell 1210 for a geographical location 1222 that encompasses both UEs 1204/1206. As the mobile BS 1208 moves away from the geographical location 1222, the mobile BS 1212 moves toward the geographical location 1222 and the mobile BS 1212 may take over the provision of the same serving cell 1210. To provide the same serving cell 1210, the mobile BS 1212 may transmit the appropriate system information (SI) and broadcast information for the cell and may take over the communications to/from the UEs 1204/1206. The SI/broadcast information may include, for example, synchronization signals and physical broadcast channel (PBCH) blocks (SSBs) transmitted to provide, for example, physical cell identity and master information block (MIB); and other system information blocks (SIBs) transmitted in a physical downlink shared channel (PDSCH). In this manner, the arriving base station may seamlessly take over the identity and responsibilities of the departing base station. The transference of the provisioning of the serving cell 1210 from the mobile BS 1208 to the mobile BS 1212 may be transparent to the UEs 1204/1206 in some embodiments. The UEs 1204/1206 may see the cell coverage as stationary and may not know that it is now being provided by a different mobile BS. As this transfer is transparent to the UEs 1204/1206, they may not incur any signaling latency due to the UE communications required with the source/target base stations in traditional handovers.

The serving cell 1210 may provide the UEs 1204/1206 with an air interface compatible with a 3GPP New Radio (NR) access technology or 3GPP Long Term Evolution (LTE) access technology. The mobile BSs 1208/1212 may in turn communicate with a core network 1214, which may be, for example, a 3GPP Fifth Generation (5G) core network (5GC). The mobile BSs 1208/1212 may be referred to as radio access node, ng-eNBs (which provide an LTE access network and connect to a 5GC), gNBs (which provide an NR access network and connect to a 5GC), or access nodes utilizing technologies of sixth generation (6G) and beyond.

The mobile BSs 1208/1212 may communicate with the UEs 1204/1206 over Uu interfaces, with one another over an Xn interface, and with the core network 1214 over a next-generation (NG) interface. In some embodiments, the mobile BSs 1208/1212 may be coupled with an access and mobility management function (AMF) 1216 of the core network 1214 with an NG-control (NG-C) interface and with a user plane function (UPF) 1218 of the core network 1214 with an NG-user (NG-U) interface.

The NG-C interface may use a next-generation application protocol (NGAP) to transfer signaling messages between the mobile BSs 1208/1212 and the AMF 1216, which may be a control plane function that provides registration management, connection management, reachability management, and mobility management services. Registration management may allow a UE to register and deregister with a 5G system. Upon registration, the UE context may be created within the core network 1214. The UE context may be a set of parameters that identify and characterize the UE. The UE context may include UE identity information, UE capability information, access and mobility information, or protocol data unit (PDU) session information. Connection management may be used to establish and release control plane signaling connection between a UE and the AMF 1216. Establishing a control plane signaling connection moves a UE from connection management (CM)-idle to CM-connected. Reachability management may allow a UE to be found and paged when a mobile terminated connection is desired. Mobility management may be used to maintain knowledge of a UE's location within a network.

In some embodiments, the AMF 1216 may include a base station tracking function (BSTF) 1220. The BSTF 1220 may be programmed with routing information for each mobile base station including, for example, mobile BSs 1208/1212. The routing information may enable the BSTF 1220 to determine a location of the mobile BSs 1208/1212 at a particular time. This information may be used to provide the mobile BSs 1208/1212 with the relevant information about neighbor base stations, upcoming geographical locations and related cell information, etc. In some embodiments, this may reduce the amount of information needed to be directly exchanged between the mobile BSs 1208/1212 over the Xn interface while the mobile BSs 1208/1212 are transferring cell provisioning responsibilities.

The UPF 1218 may provide for routing and forwarding user plane packets between mobile BSs 1208/1212 and an external network. The mobile BSs 1208/1212 may transmit uplink packets to the UPF 1218 through a general packet radio service (GPRS) tunneling protocol-user plane (GTP-U) tunnel. The UPF 1218 may remove the packet headers and forward the packets into the external data network. The UPF 1218 may map downlink packets arriving from an external data network onto specific quality of service flows belonging to specific PDU sessions before forwarding to the mobile BSs 1208/1212.

The Xn interface between mobile BS 1208 and mobile BS 1212 may include a control plane interface (Xn-C) for transferring signaling messages between neighboring base stations and a user plane interface (Xn-U) for transferring data between neighboring base stations. The mobile BSs 1208/1212 may use the Xn interface for basic mobility procedures, dual connectivity procedures, and global procedures. The basic mobility procedures include, but are not limited to, UE handover preparation and control, radio access network paging, receiving UE context, and sequence number (SN) status transfer. The dual connectivity procedures relate to adding, removing, and managing master and secondary nodes for dual connectivity operation. The global procedures include, but are not limited to, Xn set up and removal, cell activation, and handover report.

In a typical operation, the Xn interface may be set up through an automatic neighbor relation procedure (ANR) in which a UE discovers an identity of a neighbor cell for a serving cell. The serving cell may then send a query to the AMF for an appropriate IP address of the neighbor base station. The AMF would then query the neighbor node to obtain the IP address, which would then be transmitted back to the source base station. However, in some embodiments described herein, the UEs may have no knowledge of the two different base stations and reliance on the UE procedures of the ANR may not be possible. Thus, the Xn interface may be set up in other manners. For example, in some embodiments, the BSTF 1220 may provide the mobile BS 1208 and the mobile BS 1212 with information (such as IP addresses) to facilitate the establishment of the Xn interface.

In order to take over the provisioning of the cell 1210, the mobile BS 1212 may need a variety of status information with respect to the state of the cell 1210 and the UEs that are currently being served by the cell 1210. In some embodiments, the states or modes of operation of the UEs 1204/1206 may influence the type of information that needs to be acquired by the mobile BS 1212. Consider, for example, that the UE 1204 is in a RRC-connected mode at the time of transfer, while the UE 1206 is in an RRC-idle mode. The connected UE 1204 may be involved in active communications with the mobile BS 1208 at the time of transferring cell provisioning responsibilities to the mobile BS 1212. Therefore, the mobile BS 1208 may provide the mobile BS 1212 with UE-level information to allow the mobile BS 1212 to take over the communications. The UE-level information may include status information such as, but not limited to, allocated uplink and downlink resources, status of in-flight communications (for example, hybrid automatic repeat request (HARQ) processes, transmission/reception buffers, status of paging/random access/mobility procedures, etc.), and so forth.

In some embodiments, concepts related to the stationary provision of a serving cell may be abstracted to other levels. For example, in some embodiments, the mobile BSs 1208/1210 may provide stationary deployment configuration of registration/tracking/location areas to facilitate the reachability/mobility management procedures of the AMF 1216.

FIG. 13 illustrates an example UE 1300 in accordance with some embodiments. The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1300 may be a RedCap UE or NR-Light UE.

The UE 1300 may include processors 1304, RF interface circuitry 1308, memory/storage 1312, user interface 1316, sensors 1320, driver circuitry 1322, power management integrated circuit (PMIC) 1324, antenna structure 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangement of the components shown may occur in other implementations.

The components of the UE 1300 may be coupled with various other components over one or more interconnects 1332, which may represent any type of interface, input/output, bus (local, system, or expansion), transmission line, trace, optical connection, etc. that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein.

In some embodiments, the baseband processor circuitry 1304A may access a communication protocol stack 1136 in the memory/storage 1312 to communicate over a 3GPP compatible network. In general, the baseband processor circuitry 1304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1136) that may be executed by one or more of the processors 1304 to cause the UE 1300 to perform various operations described herein. The memory/storage 1312 include any type of volatile or non-volatile memory that may be distributed throughout the UE 1300. In some embodiments, some of the memory/storage 1312 may be located on the processors 1304 themselves (for example, L1 and L2 cache), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1308 may include transceiver circuitry and radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, phased array antennas, etc. The antenna 1326 may have one or more panels designed for specific frequency bands including bands in FR1 or FR2.

The user interface circuitry 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1300.

The sensors 1320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensor circuitry 1320 and control and allow access to sensor circuitry 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

In some embodiments, the PMIC 1324 may control, or otherwise be part of, various power saving mechanisms of the UE 1300. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1300 may power down for brief intervals of time and thus save power. If there is no data traffic activity for an extended period of time, then the UE 1300 may transition off to an RRC_Idle state, where it disconnects from the network and does not perform operations such as channel quality feedback, handover, etc. The UE 1300 goes into a very low power state and it performs paging where again it periodically wakes up to listen to the network and then powers down again. The UE 1300 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1328 may power the UE 1300, although in some examples the UE 1300 may be mounted deployed in a fixed location, and may have a power supply coupled to an electrical grid. The battery 1328 may be a lithium ion battery, a metal-air battery, such as a zinc-air battery, an aluminum-air battery, a lithium-air battery, and the like. In some implementations, such as in vehicle-based applications, the battery 1328 may be a typical lead-acid automotive battery.

FIG. 14 illustrates an example gNB 1400 in accordance with some embodiments. The gNB 1400 may include processors 1404, RF interface circuitry 1408, core network (CN) interface circuitry 1412, memory/storage circuitry 1416, and antenna structure 1426.

The components of the gNB 1400 may be coupled with various other components over one or more interconnects 1428.

The processors 1404, RF interface circuitry 1408, memory/storage circuitry 1416 (including communication protocol stack 1410), antenna structure 1426, and interconnects 1428 may be similar to like-named elements shown and described with respect to FIG. 13.

The CN interface circuitry 1412 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1400 via a fiber optic or wireless backhaul. The CN interface circuitry 1412 may include one or more dedicated processors or FPGAs to communicate using one or more of the aforementioned protocols. In some implementations, the CN interface circuitry 1412 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating a base station in an internet of things (IoT) non-terrestrial network (NTN), comprising generating a control transmission that indicates whether hybrid automatic repeat request (HARQ) feedback is to be disabled for a HARQ process within the IoT NTN, transmitting the control transmission to a user equipment (UE), and identifying an uplink transmission received from the UE corresponding to the control transmission.

Example 2 may include the method of example 1 or some other example herein, wherein the control transmission is a radio resource control (RRC) transmission, and wherein a physical downlink shared channel (PDSCH)-ConfigDedicated information element or a physical uplink shared channel (PUSCH)-ConfigDedicated information element of the RRC transmission includes a field indicating whether the HARQ feedback is to be disabled for the HARQ process.

Example 3 may include the method of example 2 or some other example herein, wherein the field includes a HARQ process number corresponding to the HARQ process.

Example 4 may include the method of example 1 or some other example herein, wherein the control transmission is a downlink control information (DCI) transmission for scheduling the HARQ process, and wherein the DCI transmission includes a field indicating whether the HARQ feedback is to be disabled for the HARQ process.

Example 5 may include the method of example 4 or some other example herein, wherein the field is a one-bit field indicating whether the HARQ feedback is to be disabled for the HARQ process.

Example 6 may include the method of example 1 or some other example herein, wherein the control transmission is a downlink control information (DCI) transmission for scheduling the HARQ process, and wherein a cyclic redundancy check (CRC) of the DCI transmission is masked with a radio network temporary identifier (RNTI) different from a cell radio network temporary identifier (C-RNTI) corresponding to a cell of the UE to indicate that the HARQ feedback is to be disabled.

Example 7 may include the method of example 1, wherein the control transmission is a downlink control information (DCI) transmission for scheduling the HARQ process, and wherein the DCI transmission includes a HARQ-ACK delay field or a HARQ-ACK resource offset field that has a codepoint to indicate that the HARQ feedback is to be disabled.

Example 8 may include the method of example 1 or some other example herein, wherein the control transmission is a radio resource control (RRC) transmission, wherein the method further includes generating a downlink control information (DCI) transmission that further indicates whether the HARQ feedback is to be disabled for the HARQ process, and transmitting the DCI transmission to the UE.

Example 9 may include the method of example 8 or some other example herein, wherein the RRC transmission includes an RRC field indicating whether the HARQ feedback is to be disabled for the HARQ process, and wherein the DCI transmission includes a DCI field further indicating whether the HARQ feedback is to be disabled for the HARQ process.

Example 10 may include the method of example 9 or some other example herein, wherein the RRC field includes a HARQ process number corresponding to the HARQ process, and wherein the DCI field includes the HARQ process number.

Example 11 may include the method of example 1 or some other example herein, wherein the control transmission is a radio resource control (RRC) transmission, and wherein the RRC transmission includes a configuration in a semi-persistent scheduling (SPS)-Config information element indicating whether the HARQ feedback is to be disabled for the HARQ process.

Example 12 may include the method of example 11 or some other example herein, wherein the SPS-Config information element includes a single bit indicating whether the HARQ feedback is to be disabled for the HARQ process.

Example 13 may include a method of operating a user equipment (UE) in an internet of things (IoT) non-terrestrial network (NTN), comprising identifying a control transmission received from a base station of the IoT NTN indicating that hybrid automatic repeat request (HARQ) feedback is to be disabled for a HARQ process, determining that HARQ feedback is to be disabled for the HARQ process based on the control transmission, generating an uplink transmission with a HARQ codebook based on the determination that the HARQ feedback is to be disabled for the HARQ process, and transmitting the uplink transmission to the base station.

Example 14 may include the method of example 13 or some other example herein, wherein the HARQ codebook omits a corresponding bit for the HARQ process based on the determination that the HARQ feedback is to be disabled for the HARQ process.

Example 15 may include the method of example 13 or some other example herein, wherein the HARQ codebook includes a negative acknowledgement (NACK) for the HARQ process based on the determination that the HARQ feedback is to be disabled for the HARQ process.

Example 16 may include the method of example 13 or some other example herein, wherein the HARQ process is part of a HARQ with transmission time interval (TTI) bundling, and wherein HARQ information for the HARQ process is treated as an acknowledgement (ACK) for determining the HARQ codebook.

Example 17 may include the method of example 13 or some other example herein, wherein the HARQ process is part of a HARQ with transmission time interval (TTI) bundling, wherein the control transmission indicates that all HARQ processes within the HARQ with TTI bundling are to have HARQ feedback disabled, and wherein the HARQ codebook has a HARQ-acknowledgement (ACK) bit omitted based on all the HARQ processes within the HARQ with TTI bundling having HARQ feedback disabled.

Example 18 may include the method of example 13 or some other example herein, wherein the HARQ process is part of a HARQ with transmission time interval (TTI) bundling, wherein the control transmission indicates that all HARQ processes within the HARQ with TTI bundling are to have HARQ feedback disabled, and wherein the HARQ codebook has a HARQ-acknowledgement (ACK) bit value corresponding to ACK based on all the HARQ processes within the HARQ with TTI bundling having HARQ feedback disabled.

Example 19 may include the method of example 13 or some other example herein, wherein the HARQ process is part of a HARQ with transmission time interval (TTI) bundling, wherein the control transmission indicates that all HARQ processes within the HARQ with TTI bundling are to have HARQ feedback disabled, and wherein the HARQ codebook has a HARQ-acknowledgement (ACK) bit value corresponding to negative acknowledgement (NACK) based on all the HARQ processes within the HARQ with TTI bundling having HARQ feedback disabled.

Example 20 may include the method of example 13 or some other example herein, wherein the HARQ process is to be performed on a serving cell of multiple configured serving cells, and wherein the HARQ codebook has a negative acknowledgement (NACK) value corresponding to the HARQ process based on the determination that the HARQ feedback is to be disabled for the HARQ process.

Example 21 may include the method of example 13 or some other example herein, wherein the HARQ process is to be performed on a serving cell of multiple configured serving cells, and wherein the HARQ codebook has an acknowledgement (ACK) value corresponding to the HARQ process based on the determination that the HARQ feedback is to be disabled for the HARQ process.

Example 22 may include the method of example 13 or some other example herein, wherein the HARQ process is to be performed on a serving cell of multiple configured serving cells, wherein the method further comprises determining corresponding physical downlink shared channel (PDSCH) decoding results, wherein the HARQ codebook has an acknowledgement (ACK) value or negative acknowledgment (NACK) value based on the PDSCH decoding results.

Example 23 may include the method of example 13 or some other example herein, wherein the HARQ process is to be performed on a serving cell of multiple configured serving cells, and wherein the HARQ feedback for the HARQ process is omitted from the HARQ codebook.

Example 24 may include the method of example 13 or some other example herein, wherein the HARQ process is to be performed on a serving cell of multiple configured serving cells, wherein the control transmission indicates that all scheduled HARQ processes on all of the multiple configured serving cells are to have HARQ feedback disabled, and wherein the HARQ feedback is omitted from the HARQ codebook.

Example 25 may include the method of example 13 or some other example herein, wherein the HARQ process is to be performed on a serving cell of multiple configured serving cells, wherein the control transmission indicates that all scheduled HARQ processes on all of the multiple configured serving cells are to have HARQ feedback disabled, wherein the method further comprises determining downlink control information (DCI) decoding results, wherein the HARQ codebook includes a negative acknowledgement (NACK) value or a discontinuous transmission (DTX) value for the HARQ process.

Example 26 may include the method of example 13 or some other example herein, wherein the control transmission is a downlink control information (DCI) transmission transmitted via a physical downlink control channel (PDCCH), the DCI to schedule a physical downlink shared channel (PDSCH) transmission, and wherein the method further comprises avoiding monitoring for a subsequent PDCCH transmission for a defined processing time after the PDSCH transmission.

Example 27 may include the method of example 13 or some other example herein, wherein the control transmission is a downlink control information (DCI) transmission transmitted via a physical downlink control channel (PDCCH), the DCI to schedule a physical downlink shared channel (PDSCH) transmission, and wherein the method further comprises avoiding monitoring for a subsequent PDSCH transmission for a defined processing time after the PDSCH transmission.

Example 28 may include an apparatus comprising means to perform one or more elements of a method described in or related to any of examples 1-27, or any other method or process described herein.

Example 29 may include one or more non-transitory computer-readable media comprising instructions to cause an electronic device, upon execution of the instructions by one or more processors of the electronic device, to perform one or more elements of a method described in or related to any of examples 1-27, or any other method or process described herein.

Example 30 may include an apparatus comprising logic, modules, or circuitry to perform one or more elements of a method described in or related to any of examples 1-27, or any other method or process described herein.

Example 31 may include a method, technique, or process as described in or related to any of examples 1-27, or portions or parts thereof.

Example 32 may include an apparatus comprising: one or more processors and one or more computer-readable media comprising instructions that, when executed by the one or more processors, cause the one or more processors to perform the method, techniques, or process as described in or related to any of examples 1-27, or portions thereof.

Example 33 may include a signal as described in or related to any of examples 1-27, or portions or parts thereof.

Example 34 may include a datagram, information element, packet, frame, segment, PDU, or message as described in or related to any of examples 1-27, or portions or parts thereof, or otherwise described in the present disclosure.

Example 35 may include a signal encoded with data as described in or related to any of examples 1-27, or portions or parts thereof, or otherwise described in the present disclosure.

Example 36 may include a signal encoded with a datagram, IE, packet, frame, segment, PDU, or message as described in or related to any of examples 1-27, or portions or parts thereof, or otherwise described in the present disclosure.

Example 37 may include an electromagnetic signal carrying computer-readable instructions, wherein execution of the computer-readable instructions by one or more processors is to cause the one or more processors to perform the method, techniques, or process as described in or related to any of examples 1-27, or portions thereof.

Example 38 may include a computer program comprising instructions, wherein execution of the program by a processing element is to cause the processing element to carry out the method, techniques, or process as described in or related to any of examples 1-27, or portions thereof.

Example 39 may include a signal in a wireless network as shown and described herein.

Example 40 may include a method of communicating in a wireless network as shown and described herein.

Example 41 may include a system for providing wireless communication as shown and described herein.

Example 42 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. One or more non-transitory, computer-readable media having instructions that, when executed, cause processing circuitry to:
identify a hybrid automatic repeat request (HARQ) feedback disable configuration for a HARQ process;
process a transport block associated with the HARQ process; and
determine whether to generate HARQ feedback associated with the transport block in accordance with the HARQ feedback disable configuration.

22. The one or more non-transitory, computer-readable media of claim 21, wherein the HARQ feedback disable configuration indicates that HARQ feedback is disabled for the HARQ process, and to determine whether to generate HARQ feedback includes to not generate HARQ feedback.

23. The one or more non-transitory, computer-readable media of claim 21, wherein the HARQ feedback disable configuration indicates that HARQ feedback is enabled for the HARQ process, and to determine whether to generate HARQ feedback includes to generate HARQ feedback.

24. The one or more non-transitory, computer-readable media of claim 21, wherein the HARQ feedback disable configuration is for a user equipment (UE) operating as part of a non-terrestrial network (NTN).

25. The one or more non-transitory, computer-readable media of claim 21, wherein the instructions, when executed, further cause the processing circuitry to:
generate HARQ feedback for a first semi-persistent scheduling (SPS) physical downlink shared channel (PDSCH) after SPS activation.

26. The one or more non-transitory, computer-readable media of claim 21, wherein the HARQ feedback disable configuration indicates that HARQ-acknowledgement (ACK) is disabled for the HARQ process, wherein the transport block is for a first physical downlink shared channel (PDSCH), and wherein one or more subsequent PDSCHs are not received within a time period after the first PDSCH.

27. The one or more non-transitory, computer-readable media of claim 21, wherein physical downlink control channel (PDCCH) is not monitored within a time period after the transport block.

28. The one or more non-transitory, computer-readable media of claim 27, wherein the HARQ feedback disable configuration indicates that HARQ feedback is disabled.

29. The one or more non-transitory, computer-readable media of claim 21, wherein the HARQ process is a first HARQ process bundled with one or more other HARQ processes, wherein the HARQ feedback disable configuration indicates that HARQ feedback is disabled for the first HARQ process, wherein HARQ feedback is enabled for at least one of the one or more other HARQ processes, and wherein the instructions, when executed, further cause the processing circuitry to generate a HARQ-acknowledgement (ACK) for the first HARQ process.

30. A method, comprising:
identifying a hybrid automatic repeat request (HARQ) feedback disable configuration;
determining whether a hybrid automatic repeat request (HARQ) process is configured with HARQ feedback enabled or disabled based at least in part on the HARQ feedback disable configuration for operation within a non-terrestrial network (NTN);
processing a transport block associated with the HARQ process; and
determining whether to generate HARQ feedback for the transport block based at least in part on whether the HARQ process is configured with HARQ feedback enabled or disabled.

31. The method of claim 30, wherein determining whether the HARQ process is configured with HARQ feedback enabled or disabled includes determining that HARQ feedback is disabled for the HARQ process, and wherein determining whether to generate HARQ feedback for the transport block includes determining not to generate HARQ feedback for the transport block.

32. The method of claim 30, wherein determining whether the HARQ process is configured with HARQ feedback enabled or disabled includes determining that HARQ feedback is enabled for the HARQ process, and wherein the method further comprises generating HARQ feedback for the transport block.

33. The method of claim 30, wherein the transport block corresponds to a first semi-persistent scheduling (SPS) physical downlink shared channel (PDSCH) after SPS activation, wherein the method further comprises:
generating HARQ feedback for the transport block based at least in part on the transport block corresponding to the first SPS PDSCH after the SPS activation.

34. The method of claim 30, wherein the transport block corresponds to a first physical downlink shared channel (PDSCH), wherein determining whether the HARQ process is configured with HARQ feedback enabled or disabled includes determined that the HARQ process is configured with HARQ feedback disabled, and wherein one or more subsequent PDSCHs are not to be received within a time period after the first PDSCH.

35. The method of claim 30, wherein determining whether the HARQ process is configured with HARQ feedback enabled or disabled includes determining that the HARQ process is configured with HARQ feedback disabled, wherein the HARQ process corresponds to a first transmission, and wherein a physical downlink control channel (PDCCH) is not to be received within a time period after the first transmission.

36. The method of claim 30, wherein the HARQ process is a first HARQ process bundled with one or more other HARQ processes, and wherein the method further comprises:
determining whether at least one HARQ process of the one or more other HARQ processes is configured with HARQ feedback enabled, wherein determining whether to generate HARQ feedback for the transport block is further determined based at least in part on whether the at least one HARQ process is configured with HARQ feedback enabled.

37. An apparatus comprising:
processing circuitry to:
generate a control transmission that indicates whether hybrid automatic repeat request (HARQ) feedback is to be enabled or disabled for a HARQ process during non-terrestrial network (NTN) operation; and
generate a transport block associated with the HARQ process for transmission during NTN operation; and
interface circuitry coupled with the processing circuitry, the interface circuitry to enable communication.

38. The apparatus of claim 37, wherein the control transmission indicates that HARQ feedback is to be disabled for the HARQ process, wherein the transport block is included in a first physical downlink shared channel (PDSCH), and wherein the processing circuitry is further to not generate further PDSCH for transmission within a time period after the first PDSCH.

39. The apparatus of claim 37, wherein the control transmission indicates that HARQ feedback is to be disabled for the HARQ process, and wherein the processing circuitry is further to not generate physical downlink control channel (PDCCH) within a time period after transmission of the transport block.

40. The apparatus of claim 37, wherein the control transmission is a first control transmission, wherein the HARQ process is a first HARQ process, wherein the first control transmission indicates that HARQ feedback is to be disabled for the first HARQ process, and wherein the processing circuitry is further to:
generate a second control transmission that indicates that HARQ feedback is to be enabled for a second HARQ process, the second HARQ process being bundled with the first HARQ process for HARQ bundling; and
monitor for HARQ feedback for the transport block based at least in part on HARQ feedback being enabled for the second HARQ process.
